(19) United States
(12) Patent Application Publication
(10) Pub. No.: US 2023/0021473 A1
(43) Pub. Date: Jan. 26, 2023

(54) GLASS, CHEMICALLY STRENGTHENED GLASS, AND ELECTRONIC DEVICE

(71) Applicant: AGC Inc., Tokyo (JP)

(72) Inventors: Takumi UMADA, Tokyo (JP); Kenji IMAKITA, Tokyo (JP); Shusaku AKIBA, Tokyo (JP); Yusaku MATSUO, Tokyo (JP)

(73) Assignee: AGC Inc., Tokyo (JP)

(21) Appl. No.: 17/934,294

(22) Filed: Sep. 22, 2022

Related U.S. Application Data
(63) Continuation of application No. PCT/JP2021/016839, filed on Apr. 27, 2021.

(30) Foreign Application Priority Data
Apr. 30, 2020 (JP) 2020-080385

(51) Int. Cl. C03C 3/085; C03C 3/097; C03C 3/089

(52) U.S. Cl. CPC C03C 3/085; C03C 3/097; C03C 3/089

(57) ABSTRACT

The present invention relates to a glass including, in terms of mole percentage based on oxides: SiO₂ in an amount of 45% to 65%; Al₂O₃ in an amount of 18% to 30%; Li₂O in an amount of 7% to 15%; one or more selected from Y₂O₃ and La₂O₃ in a total amount of 0% to 10%; P₂O₅ in an amount of 0% to 10%; B₂O₃ in an amount of 0% to 10%; and ZrO₂ in an amount of 0% to 4%, and satisfying the following expression: [Al₂O₃]—[R₂O]—[RO]—[P₂O₅]>0, provided that, in terms of mole percentage based on oxides, a content of Al₂O₃ is defined as [Al₂O₃], a content of P₂O₅ is defined as [P₂O₅], a total content of alkali metal oxides is defined as [R₂O], and a total content of alkali earth metal oxides is defined as [RO].

### TECHNICAL FIELD

The present invention relates to a glass, a chemically strengthened glass, and an electronic device.

### BACKGROUND ART

A chemically strengthened glass is used as a cover glass or the like of a mobile terminal. The chemically strengthened glass is a glass in which a compressive stress layer is formed on a surface portion of the glass by using a method of immersing the glass into a molten salt such as sodium nitrate to cause ion exchange between alkali ions contained in the glass and alkali ions that have a larger ionic radius and are contained in the molten salt.

Patent Literature 1 discloses a method for obtaining a chemically strengthened glass having a high surface strength and a large depth of a compressive stress layer by subjecting an aluminosilicate glass containing lithium to a two-stage chemical strengthening treatment.

The chemically strengthened glass tends to have a higher strength as a surface compressive stress value or the depth of a compressive stress layer increases. On the other hand, when the compressive stress layer is formed on the glass surface, an internal tensile stress is generated in the glass in accordance with a total amount of the compressive stress. When a value of the internal tensile stress (CT) exceeds a certain threshold value, cracking manner when the glass is cracked becomes violent. This threshold value is also referred to as a CT limit.

Patent Literature 2 discloses a high-strength glass having high crack resistance. The high-strength glass contains a large amount of Al₂O₃ and is produced by a special method referred to as a non-container method, and is unsuitable for mass production.

### CITATION LIST

### Patent Literature

### Patent Literature 1: JP-T-2013-536155

### Patent Literature 2: JP-A-2016-50155

### SUMMARY OF INVENTION

### Technical Problem

An object of the present invention is to provide a glass that has a high fracture toughness value and is easy to produce. Another object of the present invention is to provide a chemically strengthened glass that has a high strength and is less likely to be violently crushed.

### Solution to Problem

The present inventors have studied a CT limit for a chemically strengthened glass, and have found that the CT limit tends to increase as the fracture toughness value increases. Therefore, it has been considered that a high strength can be achieved by chemical strengthening while preventing violent fragmentation if a glass has excellent chemical strengthening properties and a large fracture toughness value.

In addition, the present inventors have found a glass that can be easily produced and can simultaneously achieve a high fracture toughness value and transparency by adopting a composition that can introduce an extremely minute phase-separated structure into a glass structure, and have completed the present invention.

That is, the present invention relates to a glass including, in terms of mole percentage based on oxides:

SiO₂ in an amount of 45% to 65%;

Al₂O₃ in an amount of 18% to 30%;

Li₂O in an amount of 7% to 15%;

one or more selected from Y₂O₃ and La₂O₃ in a total amount of 0% to 10%;

P₂O₅ in an amount of 0% to 10%;

B₂O₃ in an amount of 0% to 10%; and

ZrO₂ in an amount of 0% to 4%, and

satisfying the following expression:

[Al₂O₃]—[R₂O]—[RO]—[P₂O₅]>0

provided that, in terms of mole percentage based on oxides, a content of Al₂O₃ is defined as [Al₂O₃], a content of P₂O₅ is defined as [P₂O₅], a total content of alkali metal oxides is defined as [R₂O], and a total content of alkali earth metal oxides is defined as [RO].

The present invention relates to a glass including, in terms of mole percentage based on oxides:

SiO₂ in an amount of 45% to 65%;

Al₂O₃ in an amount of 18% to 30%;

Li₂O in an amount of 7% to 15%;

one or more selected from Y₂O₃ and La₂O₃ in a total amount of 2% to 10%;

P₂O₅ in an amount of 2% to 10%; and

ZrO₂ in an amount of 0% to 4%, and

having a ratio of an Al₂O₃ content to a P₂O₅ content [Al₂O₃]/[P₂O₅] of 2.5 to 13.

In one aspect of the glass of the present invention, when a content of Li₂O is defined as [Li₂O] and a total content of alkali metal oxides is defined as [R₂O] in terms of mole percentage based on oxides, [Li₂O]/[R₂O] is preferably 0.7 to 1.

In one aspect of the glass of the present invention, a fracture toughness value is preferably 0.85 MPa·m^{1/2} or more.

In one aspect of the glass of the present invention, an interparticle distance of the particles present in the glass, which is determined by small-angle X-ray scattering (SAXS) measurement, is preferably 2 nm to 100 nm.

In one aspect of the glass of the present invention, a proportion of a total number of 5-coordinated aluminum atoms and 6-coordinated aluminum atoms to a total number of aluminum atoms in the glass is preferably 1% or more and 15% or less.

In one aspect of the glass of the present invention, a Young's modulus is preferably 85 GPa or more.

In one aspect of the glass of the present invention, an arbitrary oxide MₓO_{y} (x and y are positive integers) other than SiO₂, B₂O₃, Al₂O₃, Li₂O, Na₂O, K₂O, and P₂O₅ is preferably contained, and Z represented by the following Formula (1) is preferably 5 to 100:

Z=Σ+[Al₂O₃]—[Li₂O]—[Na₂O]—[K₂O]—[P₂O₅] Formula (1)

provided that, in terms of mole percentage, a content of MₓO_{y} is defined as [MₓO_{y}], an ionic radius of M is defined as r(M), and the sum of (2y/x)/r(M)×[MₓO_{y}]×2/x is defined as Σ.

In one aspect of the glass of the present invention, a devitrification temperature is preferably 1500° C. or lower.

In one aspect of the glass of the present invention, in a case where the glass is chemically strengthened and the fragmentation number is measured by the following method, a maximum value of an absolute value of an internal tensile stress value (CT) at which the fragmentation number is 10 or less is preferably 75 MPa or more.

(Method of Measuring Fragmentation Number)

As a test glass sheet, a glass sheet having a 15 mm square and a thickness of 0.7 mm and having a mirror-finished surface is prepared. The test glass sheet is chemically strengthened under various conditions to prepare a plurality of test glass sheets having different CT values. The CT value in this case is measured using a scattered light photoelastic stress meter.

Using a Vickers tester, a diamond indenter with a tip angle of 90° is driven into a central portion of the test glass sheet to fracture the glass sheet, and the number of broken pieces of the test glass sheet is defined as the fragmentation number. The test is initiated with a driving load of a diamond indenter of 3 kgf and in a case where a glass sheet is not cracked, the driving load is increased by 1 kgf each time. The test is repeated until the glass sheet is cracked, and the number of broken pieces when the glass sheet is cracked for the first time is counted as the fragmentation number.

The present invention relates to a chemically strengthened glass having a base composition including, in terms of mole percentage based on oxides:

SiO₂ in an amount of 45% to 65%;

Al₂O₃ in an amount of 18% to 30%;

Li₂O in an amount of 7% to 15%;

one or more selected from Y₂O₃ and La₂O₃ in a total amount of 0% to 10%;

P₂O₅ in an amount of 0% to 10%;

B₂O₃ in an amount of 0% to 10%; and

ZrO₂ in an amount of 0% to 4%,

satisfying the following expression:

[Al₂O₃]—[R₂O]—[RO]—[P₂O₅]>0

provided that, in terms of mole percentage based on oxides, a content of Al₂O₃ is defined as [Al₂O₃], a content of P₂O₅ is defined as [P₂O₅], a total content of alkali metal oxides is defined as [R₂O], and a total content of alkali earth metal oxides is defined as [RO], and

having a compressive stress value (CS₅₀) at a depth of 50 μm from a glass surface of 150 MPa or more.

The present invention relates to a chemically strengthened glass having a base composition including, in terms of mole percentage based on oxides:

SiO₂ in an amount of 45% to 65%;

Al₂O₃ in an amount of 18% to 30%;

Li₂O in an amount of 7% to 15%;

one or more selected from Y₂O₃ and La₂O₃ in a total amount of 2% to 10%;

P₂O₅ in an amount of 2% to 10%; and

ZrO₂ in an amount of 0% to 4%, and

having a compressive stress value (CS₅₀) at a depth of 50 μm from a glass surface of 150 MPa or more.

In one aspect of the chemically strengthened glass of the present invention, an interparticle distance of particles present in the glass, which is determined by small-angle X-ray scattering (SAXS) measurement, is preferably 2 nm to 100 nm.

In one aspect of the chemically strengthened glass of the present invention, a depth (DOL) at which a compressive stress value is 0 is preferably 60 μm to 120 μm.

In one aspect of the chemically strengthened glass of the present invention, a surface compressive stress value (CS₀) is preferably 600 MPa to 900 MPa.

In one aspect of the chemically strengthened glass of the present invention, an internal tensile stress value (CT) is preferably −70 MPa to −120 MPa.

In one aspect of the chemically strengthened glass of the present invention, it is preferable that the compressive stress value (CS₅₀) is 180 MPa or more, and the depth (DOL) at which the compressive stress value is 0 is 80 μm or more.

In one aspect of the chemically strengthened glass of the present invention, the chemically strengthened glass preferably has a sheet shape with a thickness of 2 mm or less.

In one aspect of the chemically strengthened glass of the present invention, the chemically strengthened glass preferably has a curved surface portion with a radius of curvature of 100 mm or less.

The present invention relates to an electronic device including the chemically strengthened glass.

### Advantageous Effects of Invention

According to the present invention, it is possible to obtain a chemically strengthened glass that satisfies high fracture toughness and transparency simultaneously, is easy to produce, exhibits excellent strength, and is less likely to be violently crushed.

### BRIEF DESCRIPTION OF DRAWINGS

FIG. 1 is a diagram showing a relationship between an internal tensile stress value (CT) after chemical strengthening and the fragmentation number for two kinds of glasses.

FIG. 2 is a diagram showing an example of a stress profile in a case where the present glass is chemically strengthened.

FIG. 3 is a diagram showing an example of an electronic device including the present glass.

FIG. 4A and FIG. 4B are diagrams showing an example of a measurement result of ²⁷Al-NMR.

FIG. 5 is a diagram showing an example of a measurement result of small-angle X-ray scattering (SAXS).

### DESCRIPTION OF EMBODIMENTS

In the present specification, the expression “to” indicating a numerical range is used to include the numerical values described therebefore and thereafter as the lower limit value and the upper limit value. Hereinafter, the expression “to” in the present specification is used with the same meaning unless otherwise specified.

In the present specification, the term “chemically strengthened glass” refers to a glass after being subjected to a chemical strengthening treatment, and the term “glass for chemical strengthening” refers to a glass before being subjected to a chemical strengthening treatment.

In the present specification, the term “base composition of the chemically strengthened glass” is a glass composition of the glass for chemical strengthening. In the chemically strengthened glass, a glass composition at a depth of ½ of a sheet thickness t is the same as the base composition of the chemically strengthened glass except for a case where an extreme ion exchange treatment was performed.

In the present specification, the glass composition is expressed in terms of mole percentage based on oxides unless otherwise specified, and mol % is simply expressed as “%”.

In addition, in the present specification, “not substantially contained” means that an amount of a component is equal to or lower than a level of an impurity contained in a raw material or the like, that is, the component is not intentionally contained. Specifically, “not substantially contained” means, for example, an amount being less than 0.1 mol %.

In the present specification, the term “light transmittance” refers to an average transmittance for light having a wavelength of 380 nm to 780 nm. The “haze value” is measured using a halogen lamp C light source in accordance with JIS K7136: 2000. In the present glass, values of the light transmittance and the haze value are the same before and after chemical strengthening.

In the present specification, the term “stress profile” represents a compressive stress value with the depth from a glass surface as a variable. The term “depth of a compressive stress layer (DOL)” is a depth at which a compressive stress value (CS) is zero. The term “internal tensile stress value (CT)” refers to a tensile stress value at a depth of ½ of the sheet thickness t of the glass. In the present specification, the tensile stress value is expressed as a negative compressive stress value.

The stress profile in the present specification can be measured using a scattered light photoelastic stress meter (for example, SLP-1000 manufactured by Orihara Industrial Co., Ltd.). The scattered light photoelastic stress meter is affected by surface scattering, and measurement accuracy in a vicinity of a sample surface may decrease. However, for example, in a case where a compressive stress is generated only by ion exchange between lithium ions in a glass and external sodium ions, a compressive stress value represented by a function of a depth follows a complementary error function, and thus a stress value of a surface can be obtained by measuring an internal stress value. In a case where the compressive stress value represented by the function of the depth does not follow the complementary error function, the surface portion is measured by another method (for example, a method of measuring with a surface stress meter).

In the present specification, the CT limit is the maximum value of an absolute value of CT at which the fragmentation number measured by the following procedure is 10 or less.

### (Method of Measuring Fragmentation Number)

As a test glass sheet, a glass sheet having a 15 mm square and a thickness of 0.7 mm and having a mirror-finished surface is prepared. The test glass sheet is chemically strengthened under various conditions to prepare a plurality of test glass sheets having different CT values. The CT value in this case is measured using a scattered light photoelastic stress meter.

In addition, the depth of the compressive stress layer (DOL) is estimated. If DOL is too large with respect to the thickness of the glass sheet, a glass composition of a tensile stress layer changes, and the CT limit may not be correctly evaluated. Therefore, it is desirable to use a glass sheet having a DOL of 100 μm or less in the following test.

Using a Vickers tester, a diamond indenter with a tip angle of 90° is driven into a central portion of the test glass sheet to fracture the glass sheet, and the number of broken pieces of the test glass sheet is defined as the fragmentation number. For example, in a case where the glass sheet is cracked into two pieces, the fragmentation number is 2. In a case where very fine broken pieces are generated, the number of broken pieces that have not passed through a sieve of 1 mm is counted and defined as the fragmentation number.

However, in a case where the number of broken pieces exceeds 50, the fragmentation number may be defined as 50. This is because if the number of broken pieces is too large, most of the broken pieces pass through the sieve, so that it is difficult to accurately count the number of broken pieces, and in fact, the influence on the evaluation of the CT limit is small. The test is initiated with a driving load of a diamond indenter of 3 kgf and in a case where a glass sheet is not cracked, the driving load is increased by 1 kgf each time. The test is repeated until the glass sheet is cracked, and the number of broken pieces when the glass sheet is cracked for the first time is counted.

### (Method of Measuring CT Limit)

The fragmentation number is plotted with respect to a CT value of a test glass sheet, and an absolute value of CT at which the fragmentation number is 10 is read from a CT value at which the fragmentation number is as large as possible, which is 10 or less, and a CT value at which the fragmentation number is as small as possible, which is larger than 10, and is regarded as the CT limit. At this time, a CT value at which the fragmentation number is as large as possible, which is 10 or less, is 8 or more, and preferably 9 or more. The fragmentation number at a point where the fragmentation number is larger than 10 may be 40 or less, and more preferably 20 or less.

The following is a measurement example of the CT limit.

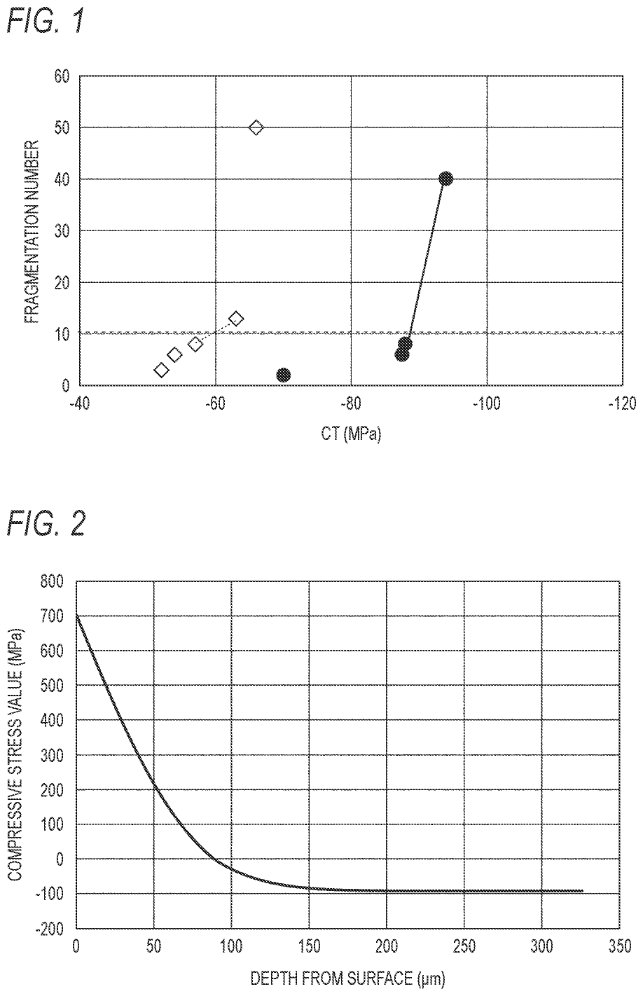

FIG. 1 is a diagram in which CT values and fragmentation numbers are plotted for glasses A and B having different glass compositions. The plotting is performed with a hollow rhombus for the glass A, and the plotting is performed with a black circle for the glass B. From FIG. 1, it can be seen that as the absolute value of CT is increased, the fragmentation number is increased, as long as the glasses have the same composition. In addition, it can be seen that, when the fragmentation number exceeds 10, the fragmentation number rapidly increases with an increase in CT.

The compositions of the glass A and the glass B are as follows.

### (Glass A)

SiO₂: 70.4%, Al₂O₃: 13.0%, Li₂O: 8.4%, Na₂O: 2.4%, B₂O₃: 1.8%, MgO: 2.8%, ZnO: 0.9%

### (Glass B)

SiO₂: 57%, Al₂O₃: 22.5%, Li₂O: 9.9%, Na₂O: 0.2%, Y₂O₃: 5.3%, P₂O₅: 3.1%, ZrO₂: 2.0%

Table 1 shows the measurement results of the stress value (CT value) and the fragmentation number of the glass A and the glass B. For the glass A, the CT limit is determined to be 60 MPa from a stress value (CT value) of −57 MPa at which the fragmentation number is 8 and a stress value (CT value) of −63 MPa at which the fragmentation number is 13. For the glass B, the CT limit is determined to be 88 MPa from a stress value (CT value) of −88 MPa at which the fragmentation number is 8 and a stress value (CT value) of −94 MPa at which the fragmentation number is 40.

TABLE 1

| | | Fragmentation | |
|---|---|---|---|
| | Stress (MPa) | number | CT limit (MPa) |
| Glass A | −52 | 3 | 60 |
| | −54 | 6 | |
| | −57 | 8 | |
| | −63 | 13 | |
| | −66 | 50 | |
| Glass B | −70 | 2 | 88 |
| | −87 | 6 | |
| | −88 | 8 | |
| | −94 | 40 | |

### <Glass>

In the case where a glass according to an embodiment of the present invention (hereinafter, also referred to as the present glass) has a sheet shape, a sheet thickness (t) thereof is for example, preferably 2 mm or less, more preferably 1.5 mm or less, still more preferably 1 mm or less, yet still more preferably 0.9 mm or less, particularly preferably 0.8 mm or less, and most preferably 0.7 mm or less, from the viewpoint of enhancing the effect of chemical strengthening. In order to obtain a sufficient strength, the sheet thickness is, for example, preferably 0.1 mm or more, more preferably 0.2 mm or more, still more preferably 0.4 mm or more, and yet still more preferably 0.5 mm or more.

A shape of the present glass may be a shape other than a sheet shape depending on an applicable product, a use, or the like. In addition, the glass sheet may have an edged shape in which the thicknesses of an outer periphery are different. The form of the glass sheet is not limited thereto. For example, two main surfaces may not be parallel to each other, and all or a part of one or both of the two main surfaces may be curved surfaces. More specifically, the glass sheet may be, for example, a flat sheet-shaped glass sheet having no warpage or a curved glass sheet having a curved surface.

The light transmittance of the present glass is preferably 85% or more in a case where the thickness is 0.7 mm. The light transmittance of 85% or more is preferable because a screen of a display can be easily seen in a case where the glass is used as a cover glass of a portable display. The light transmittance is preferably 88% or more, and more preferably 90% or more. The light transmittance is preferably as high as possible, but is generally 91% or less. In a case where the thickness is 0.7 mm, the typical light transmittance of the present glass is 90.5%.

In a case where an actual thickness of the glass is not 0.7 mm, the light transmittance in the case of 0.7 mm can be calculated from Lambert-Beer law based on a measured value.

In a case where the total visible light transmittance of the present glass having a sheet thickness of t [mm] is 100×T [%] and the surface reflectance of one surface thereof is 100×R [%], a relationship of T=(1−R)²×exp (−αt) is established using a constant α by incorporating Lambert-Beer law.

From this relationship, when a is represented by R, T, and t, and t=0.7 mm is satisfied, as R is not changed depending on the sheet thickness, the total visible light transmittance T_{0.7} in terms of 0.7 mm can be calculated as T_{0.7}=100×T^{0.7/t}/(1−R)\hat{ }(1.4/t−2) [%]. Here, X\hat{ }Y means X^{Y}.

The surface reflectance may be determined by calculation from a refractive index or may be actually measured. In a case where the sheet thickness t is larger than 0.7 mm, the light transmittance may be measured by adjusting the sheet thickness to 0.7 mm by polishing, etching, or the like.

In the case of a thickness of 0.7 mm, the haze value of the present glass is preferably 0.2% or less, more preferably 0.1% or less, still more preferably 0.08% or less, yet still more preferably 0.05% or less, and particularly preferably 0.03% or less. The haze value is preferable as small as possible, but the haze value is generally 0.01% or more. In a case where the thickness is 0.7 mm, a typical haze value of the present glass is 0.02%.

In a case where the total visible light transmittance of the present glass having a sheet thickness oft [mm] is 100×T [%] and the haze value is 100×H [%], dH/dt∞exp (−αt)×(1−H) is satisfied using the constant α described above by incorporating Lambert-Beer law. That is, the haze value can be considered to increase by an amount proportional to the internal linear transmittance as the sheet thickness increases, so that the haze value H_{0.7} in the case of 0.7 mm is determined by the following formula. Here, “X\hat{ }Y” means “X^{Y}”

H_{0.7}=100×[1−(1−H)\hat{ }{((1−R)²−T_{0.7})/((1−R)²−T)}][%]

In a case where the sheet thickness t is larger than 0.7 mm, the measurement may be performed after adjusting the sheet thickness to 0.7 mm by polishing, etching, or the like.

The fracture toughness value of the present glass is preferably 0.85 MPa·m^{1/2} or more. A glass having a large fracture toughness value has a large CT limit, so that violent fragmentation is less likely to occur even if a large surface compressive stress layer is formed by chemical strengthening. The fracture toughness value is more preferably 0.86 MPa·m^{1/2} or more, still more preferably 0.88 MPa·m^{1/2} or more, and yet still more preferably 0.90 MPa·m^{1/2} or more. The fracture toughness value of the glass is generally 2.0 MPa·m^{1/2} or less, and typically 1.5 MPa·m^{1/2} or less.

The fracture toughness value can be measured using, for example, a DCDC method (Acta Metall. mater. Vol. 43, pp. 3453-3458, 1995).

In the present glass, the CT limit described above is preferably 70 MPa or more, more preferably 73 MPa or more, and still more preferably 75 MPa or more. The CT limit of the present glass is generally 95 MPa or less.

The present glass is a lithium aluminosilicate glass. Specifically, the present glass is a glass containing SiO₂ in an amount of 40% or more, Al₂O₃ in an amount of 18% or more, and Li₂O in an amount of 5% or more. The lithium aluminosilicate glass contains lithium ions that are alkali ions having the smallest ion radius, so that a chemically strengthened glass having a preferable stress profile can be obtained by a chemical strengthening treatment in which ions are exchanged using various molten salts.

The present glass includes, in terms of mole percentage based on oxides,

SiO₂ in an amount of 45% to 65%;

Al₂O₃ in an amount of 18% to 30%;

Li₂O in an amount of 7% to 15%;

one or more selected from Y₂O₃ and La₂O₃ in a total amount of 0% to 10%;

P₂O₅ in an amount of 0% to 10%;

B₂O₃ in an amount of 0% to 10%; and

ZrO₂ in an amount of 0% to 4%.

Hereinafter, the glass composition will be described.

In the present glass, SiO₂ is a component constituting a framework of a glass network structure, and is a component for increasing chemical durability. In order to obtain sufficient chemical durability, the content of SiO₂ is preferably 45% or more, more preferably 46% or more, still more preferably 47% or more, yet still more preferably 48% or more, and particularly preferably 50% or more.

The content of SiO₂ is preferably 65% or less, more preferably 63% or less, still more preferably 60% or less, and yet still more preferably 59% or less. In order to facilitate bending forming and the like, the content of SiO₂ is preferably 58% or less.

Al₂O₃ is an essential component of the present glass, and is a component contributing to an increase in the strength of the glass. The content of Al₂O₃ is preferably 18% or more, more preferably 19% or more, and still more preferably 20% or more in order to obtain a sufficient strength. The content of Al₂O₃ is preferably 30% or less, more preferably 28% or less, still more preferably 26% or less, yet still more preferably 25% or less, and most preferably 24% or less, in order to increase the meltability.

SiO₂ and Al₂O₃ are components constituting a network of a glass. In order to contain a sufficient amount of network components and improve chemical durability and brittleness of the glass, the total amount of SiO₂+Al₂O₃ is preferably 60% or more, more preferably 62% or more, still more preferably 64% or more, and yet still more preferably 66% or more. When the amount of the network components is too large, the Young's modulus of the glass decreases, and thus the total amount of SiO₂+Al₂O₃ is preferably 90% or less, more preferably 87% or less, still more preferably 84% or less, yet still more preferably 83% or less, particularly preferably 82% or less, and most preferably 81% or less.

Li₂O is an essential component of a lithium aluminosilicate glass. The content of Li₂O is 5% or more, preferably 6% or more, more preferably 7% or more, still more preferably 8% or more, and yet still more preferably 9% or more, in order to increase the depth of the compressive stress layer (DOL) by chemical strengthening.

In addition, in order to prevent the occurrence of devitrification when the glass is produced or bent, the content of Li₂O is preferably 15% or less, more preferably 14% or less, still more preferably 13% or less, and yet still more preferably 12% or less.

The present glass may contain other alkali metal oxides in order to adjust chemical strengthening properties, and to enhance the stability of the molten glass. The other alkali metal oxides are preferably Na₂O and K₂O, and more preferably Na₂O. K₂O may not be substantially contained. In order to further increase the fracture toughness value, the total content of the other alkali metal oxides in the case of containing the other alkali metal oxides is preferably 10% or less, more preferably 8% or less, still more preferably 6% or less, yet still more preferably 5% or less, particularly preferably 4% or less, further particularly preferably 2% or less, still further particularly preferably 1% or less, and most preferably 0.5% or less.

Hereinafter, alkali metal oxides such as Li₂O, Na₂O, and K₂O are collectively referred to as R₂O. R₂O is a component for lowering the melting temperature of the glass.

In the present glass, a ratio [Li₂O]/[R₂O] of the content of Li₂O to the total content of alkali metal oxides is preferably 0.7 or more, more preferably 0.75 or more, still more preferably 0.8 or more, and particularly preferably 0.85 or more. In addition, [Li₂O]/[R₂O] is 1 or less, and more preferably 0.99 or less.

Neither Y₂O₃ nor La₂O₃ is essential, but one or both of them are preferably contained in order to increase the solubility. The total content [Y₂O₃]+[La₂O₃] of Y₂O₃ and La₂O₃ is preferably 0.5% or more, more preferably 1% or more, still more preferably 2% or more, yet still more preferably 3% or more, particularly preferably 4% or more, and further particularly preferably 5% or more.

In addition, [Y₂O₃]+[La₂O₃] is preferably 10% or less, more preferably 8% or less, still more preferably 7% or less, yet still more preferably 6% or less, and particularly preferably 5% or less, in order to maintain a high strength.

In order to enhance the solubility, the present glass more preferably contains Y₂O₃. The content of Y₂O₃ is preferably 0.5% or more, more preferably 1% or more, still more preferably 2% or more, even more preferably 3% or more, and yet still more preferably 5% or more.

The content of Y₂O₃ is preferably 10% or less, more preferably 8% or less, and still more preferably 6% or less in order to increase the strength of the glass.

P₂O₅ is a component constituting a network in combination with Al₂O₃ in a glass. In order to improve the ion diffusion rate during the chemical strengthening treatment, the present glass may contain P₂O₅. The content of P₂O₅ is preferably 0% or more, more preferably 1% or more, and still more preferably 2% or more.

In order to increase the chemical durability, the content of P₂O₅ is preferably 10% or less, more preferably 9% or less, still more preferably 8% or less, yet still more preferably 6% or less, particularly preferably 4% or less, and most preferably 3% or less.

In a case where the present glass contains P₂O₅, the glass network is constituted not only by SiO₂ but also by a combination of P₂O₅ and Al₂O₃. Therefore, the strength is increased, and the devitrification temperature is likely to be lowered. In the case where the present glass contains P₂O₅, a ratio [Al₂O₃]/[P₂O₅] of the Al₂O₃ content to the P₂O₅ content is preferably 2.5 or more, more preferably 3 or more, and still more preferably 4 or more, in order to lower the devitrification temperature. This is because when the amount of P₂O₅ is too large, devitrification of aluminum phosphates is likely to occur. In order to prevent crystal precipitation of aluminum silicate or the like during glass melting, [Al₂O₃]/[P₂O₅] is preferably 13 or less, more preferably 10 or less, and still more preferably 8 or less.

ZrO₂ is preferably contained in order to increase the surface compressive stress of the chemically strengthened glass. In a case where the present glass contains ZrO₂, the content of ZrO₂ is preferably 0% or more, more preferably 0.2% or more, still more preferably 0.5% or more, and particularly preferably 1% or more.

In order to prevent devitrification during the melting, the content of ZrO₂ is preferably 4% or less, more preferably 3.5% or less, still more preferably 3% or less, and yet still more preferably 2% or less.

TiO₂ tends to increase the surface compressive stress of the chemically strengthened glass like ZrO₂, and may be contained. In a case where the present glass contains TiO₂, the content of TiO₂ is preferably 0.1% or more. The content of TiO₂ is preferably 5% or less, more preferably 3% or less, still more preferably 1% or less, and particularly preferably 0.5% or less, in order to prevent devitrification during the melting.

The total content (TiO₂+ZrO₂) of TiO₂ and ZrO₂ is preferably 5% or less, and more preferably 3% or less. (TiO₂+ZrO₂) is preferably 1% or more, and more preferably 1.5% or more.

Alkali earth metal oxides such as MgO, CaO, SrO, BaO, and ZnO are not essential components, but may be contained. All of these components are components that increase the meltability of the glass, and tend to lower the ion exchange performance. The total content (MgO+CaO+SrO+BaO+ZnO) of MgO, CaO, SrO, BaO, and ZnO is preferably 10% or less, more preferably 5% or less, still more preferably 4% or less, and yet still more preferably 3% or less.

In the alkali earth metal oxides, when MgO is contained, the effect of chemical strengthening tends to be enhanced. In a case where the present glass contains MgO, the content of MgO is preferably 0.1% or more, and more preferably 0.5% or more. The content of MgO is preferably 10% or less, more preferably 5% or less, still more preferably 4% or less, and yet still more preferably 3% or less.

In a case where the present glass contains CaO, the content of CaO is preferably 0.5% or more, and more preferably 1% or more. In order to improve the ion exchange performance, the content of CaO is preferably 5% or less, and more preferably 3% or less.

In a case where the present glass contains SrO, the content of SrO is preferably 0.5% or more, and more preferably 1% or more. In order to improve the ion exchange performance, the content of SrO is preferably 5% or less, and more preferably 3% or less.

In a case where the present glass contains BaO, the content of BaO is preferably 0.5% or more, and more preferably 1% or more. In order to improve the ion exchange performance, the content of BaO is preferably 5% or less, more preferably 1% or less, and it is still more preferable that BaO is not substantially contained.

ZnO is a component for improving the meltability of the glass, and the present glass may contain ZnO. In a case where the present glass contains ZnO, the content of ZnO is preferably 0% or more, more preferably 0.2% or more, and still more preferably 0.5% or more. In order to increase the weather resistance of the glass, the content of ZnO is preferably 5% or less, and more preferably 3% or less.

B₂O₃ is not essential, but may be added in order to improve the meltability during glass production. In order to enhance the stability by reducing a slope of a stress profile in a vicinity of a surface of the chemically strengthened glass during chemically strengthening, the content of B₂O₃ is preferably 0.5% or more, more preferably 1% or more, still more preferably 2% or more, and yet still more preferably 3% or more. B₂O₃ is a component for causing stress relaxation easily after chemical strengthening, so that, in order to further increase the surface compressive stress of the chemically strengthened glass, the content of B₂O₃ is preferably 10% or less, more preferably 8% or less, still more preferably 6% or less, yet still more preferably 5% or less, particularly preferably 4% or less, and most preferably 3% or less.

Nb₂O₅ and Ta₂O₅ may be contained to prevent fragmentation of a chemically strengthened glass. In a case where the present glass contains these components, the total content of Nb₂O₅ and Ta₂O₅ is preferably 0.2% or more, more preferably 0.5% or more, still more preferably 1% or more, particularly preferably 1.5% or more, and most preferably 2% or more. The total content of Nb₂O₅ and Ta₂O₅ is preferably 3% or less, and more preferably 2.5% or less.

In a case where the glass is colored, coloring components may be added within a range that does not inhibit the achievement of desired chemical strengthening properties. Examples of the coloring components include Co₃O₄, MnO₂, Fe₂O₃, NiO, CuO, Cr₂O₃, V₂O₅, Bi₂O₃, SeO₂, CeO₂, Er₂O₃, Nd₂O₃, and the like. These components may be used alone or in combination. The total content of the coloring components is preferably 7% or less. Accordingly, devitrification of the glass can be prevented. The content of the coloring component is more preferably 5% or less, still more preferably 3% or less, and particularly preferably 1% or less. In a case where it is desired to increase the transparency of the glass, it is preferable that these components are not substantially contained.

In addition, the present glass may appropriately contain SO₃, chlorides, fluorides, and the like as a refining agent during the melting of the glass. It is preferable that the present glass does not substantially contain As₂O₃. In a case where the present glass contains Sb₂O₃, the content of Sb₂O₃ is preferably 0.3% or less, more preferably 0.1% or less, and it is most preferable that Sb₂O₃ is not substantially contained.

In the present glass, an aluminum atom (hereinafter, sometimes referred to as Al) may have an oxygen coordination number from 4-coordination to 6-coordination. Among these, 4-coordinated Al improves the chemical durability of the glass. The 5-coordinated and 6-coordinated Al improves the fracture toughness and improves the strength of the glass. In a general glass, only 4-coordinated Al is present. However, in the present glass, the coordination number of aluminum atoms is adjusted and thus it is presumed that excellent properties are obtained since the present glass has an extremely minute phase-separated structure described later, and thus has high fracture toughness while maintaining transparency.

A proportion of the total number of 5-coordinated and 6-coordinated aluminum atoms to the total number of aluminum atoms in the present glass is preferably 1% or more. The proportion is more preferably 2% or more, still more preferably 3% or more, and most preferably 4% or more. On the other hand, the proportion of the total number of 5-coordinated and 6-coordinated aluminum atoms is preferably 15% or less, more preferably 14% or less, still more preferably 13% or less, yet still more preferably 12% or less, particularly preferably 11% or less, further particularly preferably 10% or less, still further particularly preferably 9% or less, and most preferably 8% or less, from the viewpoint of preventing deterioration of acid resistance. The proportion of the total number of 5-coordinated and 6-coordinated aluminum atoms to the total number of aluminum atoms in the glass can be adjusted to a desired range by adjusting the glass composition. The coordination number of the aluminum atoms can be measured by ²⁷Al-NMR. The “proportion of the total number of 5-coordinated and 6-coordinated aluminum atoms to the total number of aluminum atoms” refers to a proportion obtained by calculating a proportion of 4-coordinated Al, a proportion of 5-coordinated Al, and a proportion of 6-coordinated Al based on the measurement results of ²⁷Al-NMR, and summing the proportion of 5-coordinated Al and the proportion of 6-coordinated Al among them. Preferable conditions of the ²⁷Al-NMR measurement will be described later in Examples.

When the content of Al₂O₃ is defined as [Al₂O₃], the content of P₂O₅ is defined as [P₂O₅], the total content of the alkali metal oxides is defined as [R₂O], and the total content of the alkali earth metal oxides is defined as [RO], the present glass satisfies [Al₂O₃]—[R₂O]—[RO]—[P₂O₅]>0.

The present inventors consider that, in order to obtain a glass containing 5-coordinated and 6-coordinated Al, the amount of a network modifier (NWM) needs to be smaller than the amount of Al₂O₃, which is a network former (NWF). That is, it is required to make the total amount of NWM of oxides of alkali metals and alkali earth metals smaller than the amount of Al₂O₃. That is, when “[Al₂O₃]—[R₂O]—[RO]—[P₂O₅]” described above is larger than 0, at least one of 5-coordinated and 6-coordinated aluminum atoms is present in the glass. This value is preferably 1 or more, more preferably 2 or more, still more preferably 3 or more, and most preferably 4 or more.

From the viewpoint of preventing an increase in the devitrification temperature and facilitating sheet forming, “[Al₂O₃]—[R₂O]—[RO]—[P₂O₅]” is preferably 12 or less, more preferably 11 or less, still more preferably 9 or less, yet still more preferably 8 or less, particularly preferably 7 or less, further particularly preferably 6 or less, and most preferably 5 or less.

In the present glass, the interparticle distance of the particles present in the glass, which is determined by small-angle X-ray scattering (SAXS) measurement, is preferably 2 to 100 nm. Since the general glass is uniform amorphous, internal scattering is not observed in the SAXS measurement. In the present glass, as the composition is adjusted so that at least one of 5-coordinated and 6-coordinated Al is present, the present glass becomes a glass containing extremely minute scattering. Glass in which scattering is observed is known as a phase-separated glass. The phase-separated glass is generally a cloudy glass. On the other hand, the present inventors have found that, by having an extremely minute phase-separated structure, the present glass becomes a glass whose transparency is maintained and which has high fracture toughness (KIC) capable of preventing crack development. In the present specification, “having transparency” means that, for example, no cloudiness is observed by visual observation, and that, for example, the haze value is preferably 0.2% or less, and is more preferably 0.1% or less.

The interparticle distance calculated from the small-angle X-ray scattering measurement represents a distance between particles contained in the glass. It is considered that the number of particle structures contained in the glass is increased as the interparticle distance is reduced, and therefore, scattering tends to be stronger and transmittance tends to decrease. The interparticle distance is preferably 2 nm or more from the viewpoint of preventing the strong scattering and improving the transmittance. The interparticle distance is more preferably 5 nm or more, still more preferably 10 nm or more, and yet still more preferably 15 nm or more. The interparticle distance is preferably 100 nm or less from the viewpoint of increasing the effect of preventing crack elongation and improving fracture toughness. The interparticle distance is more preferably 90 nm or less, still more preferably 80 nm or less, yet still more preferably 70 nm or less, particularly preferably 60 nm or less, further particularly preferably 50 nm or less, still further particularly preferably 40 nm or less, yet still further particularly preferably 30 nm or less, and most preferably 20 nm or less.

The present glass may contain one or more oxides selected from Li₂O, Na₂O, K₂O and P₂O₅. The present glass may contain an arbitrary oxide MₓO_{y} (x and y are positive integers) other than SiO₂, B₂O₃, Al₂O₃, Li₂O, Na₂O, K₂O, and P₂O₅, or may contain two or more kinds of MₓO_{y}.

Examples of MₓO_{y} include MgO, CaO, SrO, Y₂O₃, La₂O₃, TiO₂, ZrO₂, Nb₂O₅, Ta₂O₅, WO₃, and the like.

When the present glass contains MₓO_{y}, Z represented by the following Formula (1) is preferably 5 to 100,

Z=Σ+[Al₂O₃]—[Li₂O]—[Na₂O]—[K₂O]—[P₂O₅] Formula (1)

provided that the content of the oxide in terms of mole percentage is defined as [MₓO_{y}], the ionic radius of M is defined as r(M), and the sum of (2y/x)/r(M)×[MₓO_{y}]×2/x is defined as Σ.

Z represented by the Formula (1) contributes to determination of the coordination number of Al in the glass. As a result of intensive studies made by the present inventors, the influence of each component on the coordination number of Al is considered as follows.

The coordination number of Al tends to increase as cations having a small ionic radius and a high valence is contained in a larger amount. In addition, Al itself is a component for increasing the coordination number by being contained in a large amount. On the other hand, components such as alkali metal oxides and P₂O₅ are components that easily make Al have a coordination number of 4.

Since the coordination number of Al has a preferable range in order to balance the chemical durability and the strength, it is preferable that a value of Z represented by the formula (1) is also within such a range. From this viewpoint, the value of Z represented by the formula (1) is preferably 5 or more, more preferably 6 or more, still more preferably 7 or more, yet still more preferably 8 or more, particularly preferably 9 or more, further particularly preferably 10 or more, still further particularly preferably 11 or more, and most preferably 12 or more. For the same reason, the value of Z is preferably 100 or less. The value of Z is more preferably 80 or less, still more preferably 60 or less, yet still more preferably 40 or less, and most preferably 20 or less.

In the present glass, a boron atom (hereinafter, sometimes referred to as B) may have an oxygen coordination number of 3-coordination or 4-coordination. In a general boron atom-containing glass, the oxygen coordination number of boron is mainly 3-coordination. Although 4-coordinated boron is considered to have an effect of increasing the Young's modulus, there is a concern that the acid resistance may decrease if the amount of 4-coordinated boron is too large.

In a case where the present glass contains B₂O₃, a proportion of the number of 4-coordinated boron atoms to the total number of boron atoms is preferably 1% or more, more preferably 2% or more, and still more preferably 3% or more, from the viewpoint of improving the Young's modulus. In addition, such a proportion is preferably 10% or less, more preferably 7% or less, and still more preferably 5% or less, from the viewpoint of preventing a decrease in acid resistance.

The oxygen coordination number of the boron atoms can be measured by ¹¹B-NMR. The “proportion of the number of 4-coordinated boron atoms to the total number of boron atoms” is a proportion of 4-coordinated boron atoms calculated from the measurement results of ¹¹B-NMR. Preferable conditions of the ¹¹B-NMR measurement will be described later in Examples.

The devitrification temperature of the present glass is preferably 1500° C. or lower, more preferably 1450° C. or lower, still more preferably 1430° C. or lower, yet still more preferably 1400° C. or lower, particularly preferably 1350° C. or lower, further particularly preferably 1300° C. or lower, still further particularly preferably 1275° C. or lower, and most preferably 1250° C. or lower. The present glass has a low devitrification temperature by adjusting the composition to a specific range, so that it is relatively easy to produce, and specifically, mass production by a float method or the like is possible. The devitrification temperature of the present glass is generally 1250° C. or higher.

The devitrification viscosity η_{L} (unit: dPa·s) of the present glass preferably has a logarithm log η_{L} of 2 or more. When the devitrification viscosity is large, forming by a float method or the like is easily performed.

The present glass preferably has a viscosity at 1650° C. of 10² dPa·s or less.

The softening point of the present glass is preferably 1000° C. or lower, and more preferably 950° C. or lower. This is because the lower the softening point of the glass is, the lower the heat treatment temperature and the energy consumption is in the case of performing bending forming or the like, and in addition, the lower the load on equipment is. A glass having an excessively low softening point tends to have a low strength because the stress introduced during the chemical strengthening treatment is likely to be relaxed. Therefore, the softening point is preferably 550° C. or higher. The softening point is more preferably 600° C. or higher, and still more preferably 650° C. or higher.

The softening point can be measured by a fiber stretching method described in JIS R3103-1: 2001.

The glass softening point of the present glass is likely to be equal to or lower than a temperature at which a surface of a carbon mold starts to deteriorate under an air atmosphere, and it is easy to perform bending forming. The bending forming method will be described later.

The glass transition point (Tg) of the present glass is preferably 800° C. or lower, more preferably 780° C. or lower, and still more preferably 750° C. or lower, from the viewpoint of production of a glass sheet. The glass transition point is preferably 500° C. or higher, more preferably 600° C. or higher, and still more preferably 650° C. or higher.

The 3D formable temperature of the present glass is preferably 820° C. or lower, more preferably 800° C. or lower, and still more preferably 770° C. or lower, from the viewpoint of mold abrasion of the 3D forming machine. The 3D formable temperature is preferably 500° C. or higher, more preferably 600° C. or higher, and still more preferably 650° C. or higher. The 3D formable temperature means a temperature at which 3D forming can be performed while maintaining transparency, and is a value measured by a method described in Examples.

In the present glass, the composition is adjusted to a specific range, so that in a case where the present glass is subjected to bending forming by being heated on a carbon mold, carbon transfer from the carbon mold is small, and the haze is less likely to deteriorate. Therefore, it is also suitable for a cover glass having a curved surface shape described later.

The Young's modulus of the present glass is preferably 85 GPa or more, more preferably 87 GPa or more, still more preferably 89 GPa or more, even more preferably 91 GPa or more, yet still more preferably 93 GPa or more, and most preferably 95 GPa or more from the viewpoint of rigidity. The Young's modulus is preferably 110 GPa or less, more preferably 105 GPa or less, and still more preferably 102 GPa or less.

The Poisson's ratio of the present glass is preferably 0.22 or more, more preferably 0.23 or more, and still more preferably 0.24 or more, from the viewpoint of improving strength. The upper limit of the Poisson's ratio is not limited, and is, for example, preferably 0.30 or less, more preferably 0.29 or less, and still more preferably 0.28 or less.

The present glass is a glass having a large fracture toughness value and being less likely to be cracked, and is easy to produce, and thus, the present glass is useful as a structural member such as a window glass.

The present glass has a large CT limit in the case of chemical strengthening, so that the present glass is excellent as a glass for chemical strengthening.

### <Chemically Strengthened Glass>

The chemically strengthened glass according to the present embodiment (hereinafter, also referred to as the present chemically strengthened glass) is obtained by subjecting the present glass described above to a chemical strengthening.

The present chemically strengthened glass has a relatively large CT limit, so that a compressive stress value (CS₅₀) at a depth of 50 μm from a glass surface can be increased. CS₅₀ is preferably 150 MPa or more, more preferably 180 MPa or more, and still more preferably 200 MPa or more. CS₅₀ is generally 250 MPa or less.

In the present chemically strengthened glass, the depth (DOL) at which the compressive stress value is 0 is preferably 60 μm or more, and more preferably 75 μm or more. DOL is more preferably 80 μm or more, still more preferably 85 μm or more, particularly preferably 90 μm or more, and most preferably 100 μm or more. DOL is preferably t/4 or less, and more preferably t/5 or less, because too large DOL with respect to the sheet thickness t causes an increase in CT. Specifically, for example, in a case where the sheet thickness t is 0.6 mm, DOL is preferably 150 μm or less, and more preferably 120 μm or less.

Regarding the present chemically strengthened glass, from the viewpoint of preventing bending fracture and fracture caused by collision, the compressive stress value CS₅₀ is preferably 150 MPa or more, more preferably 180 MPa or more, and still more preferably 200 MPa or more, and the depth DOL at which the compressive stress value is 0 is preferably 60 μm or more, more preferably 70 μm or more, still more preferably 80 μm or more, even more preferably 85 μm or more, and yet still more preferably 90 μm or more.

A surface compressive stress value (C₅₀) of the present chemically strengthened glass is preferably 500 MPa or more, more preferably 550 MPa or more, and still more preferably 600 MPa or more. CS₀ is preferably 1000 MPa or less, and more preferably 900 MPa or less in order to prevent chipping when receiving an impact.

The surface compressive stress value CS₀ may be measured by using a surface stress meter using photoelasticity (for example, FSM6000 manufactured by Orihara Industrial Co., Ltd.). However, in a case where the content of Na in the glass before chemical strengthening is small, measurement with a surface stress meter is difficult.

In such a case, the magnitude of the surface compressive stress may be estimated by measuring a bending strength. This is because the bending strength tends to increase as the surface compressive stress increases.

The bending strength can be evaluated, for example, by performing a four-point bending test on a strip-shaped test piece having a size of 10 mm×50 mm under the conditions that a distance between outer fulcrums of a supporting tool is 30 mm, a distance between inner fulcrums is 10 mm, and a crosshead speed is 0.5 mm/min. The number of test pieces is, for example, 10.

The four-point bending strength of the present chemically strengthened glass is preferably 500 MPa or more, more preferably 550 MPa or more, and still more preferably 600 MPa or more. The four-point bending strength of the present chemically strengthened glass is generally 1000 MPa or less, and typically 900 MPa or less.

An internal tensile stress value (CT) of the present chemically strengthened glass is preferably −70 MPa or less, more preferably −75 MPa or less, and still more preferably −80 MPa or less because a sufficient compressive stress is introduced into the glass surface. CT is preferably −120 MPa or more, more preferably −110 MPa or more, and still more preferably −100 MPa or more, from the viewpoint of preventing explosive fragmentation at the time of receiving damage.

The base composition of the present chemically strengthened glass is the same as the glass composition of the present glass described above. That is, a glass composition of the present chemically strengthened glass is the same as the glass composition of the present glass described above in the center portion in the sheet thickness direction. The present chemically strengthened glass is basically the same as the present glass as a whole except that the concentration of alkali metal ions is different due to the chemical strengthening treatment, and thus the description thereof will be omitted. For example, it is considered that the coordination number of Al and the interparticle distance in the present glass described above hardly change even after chemical strengthening.

### <Chemically Strengthened Glass Sheet>

The present chemically strengthened glass may have a sheet shape. Hereinafter, a sheet-shaped chemically strengthened glass (chemically strengthened glass sheet) will be described.

The sheet thickness (t) of the chemically strengthened glass sheet is, for example, preferably 2 mm or less, more preferably 1.5 mm or less, still more preferably 1 mm or less, yet still more preferably 0.9 mm or less, particularly preferably 0.8 mm or less, and most preferably 0.7 mm or less. In order to obtain a sufficient strength, the sheet thickness (t) is, for example, preferably 0.1 mm or more, more preferably 0.2 mm or more, still more preferably 0.4 mm or more, and yet still more preferably 0.5 mm or more.

The present chemically strengthened glass sheet may be a flat sheet.

The present chemically strengthened glass sheet may have, for example, a curved surface shape having a curved surface portion having a radius of curvature of 100 mm or less.

In recent years, in order to improve operability and visibility of a display member, a cover glass having a curved surface shape is required in some cases. The present chemically strengthened glass is suitable for such applications.

### <Glass and Method of Producing Glass Sheet>

The present chemically strengthened glass is obtained by producing the present glass and then chemically strengthening the glass by an ion exchange treatment.

The present glass can be produced by, for example, a general method. For example, raw materials of the components of the glass are blended and heated and melted in a glass melting furnace. Thereafter, the glass is homogenized by a known method and formed into a desired shape such as a glass sheet, followed by being annealed.

In a case where the present chemically strengthened glass has a sheet shape, the glass is formed into a sheet shape by a float method, a press method, a down-draw method, or the like.

Thereafter, the formed glass is subjected to a grinding and polishing treatment as necessary to form a glass sheet. In the case where the glass sheet is cut into a predetermined shape and size or chamfered, it is preferable to cut or chamfer the glass sheet before the chemical strengthening treatment described later is performed on the glass sheet, as a compressive stress layer is also formed on the end surface by the subsequent chemical strengthening treatment.

In a case where the present chemically strengthened glass sheet has a curved surface shape, it is preferable that a flat sheet glass is produced, followed by performing bending forming, and then, chemical strengthening is performed on the glass sheet.

As the bending forming method, a self-weight forming method, a vacuum forming method, a press forming method, or the like can be employed. Two or more kinds of bending forming methods may be used in combination.

The self-weight forming method is a method in which a glass sheet is placed on a shaping mold, the glass sheet is heated to be softened, and then the glass sheet is made to conform to the shaping mold by gravity.

The vacuum forming method is a method in which a glass sheet is placed on a shaping mold, a periphery of the glass sheet is sealed, and then a space between the shaping mold and the glass sheet is reduced in pressure to bend the glass sheet. In this case, an upper surface side of the glass sheet may be pressed.

The press forming method is a method in which a glass sheet is placed between an upper mold and a lower mold of a shaping mold including the upper mold and the lower mold, the glass sheet is heated, and a press load is applied between the upper and lower shaping molds to bend and form the glass sheet into a predetermined shape.

In either case, a carbon mold is widely used as a shaping mold.

The chemical strengthening is performed by an ion exchange treatment.

The chemical strengthening treatment (ion exchange treatment) can be performed, for example, by immersing a glass sheet in a molten salt such as potassium nitrate heated to 360° C. to 600° C. for 0.1 to 500 hours. The heating temperature for the molten salt is preferably 375° C. to 500° C., and the immersion time of the glass sheet in the molten salt is preferably 0.3 to 200 hours.

Examples of the molten salt for performing the chemical strengthening treatment include a nitrate, a sulfate, a carbonate, a chloride, and the like. Among them, examples of the nitrate include lithium nitrate, sodium nitrate, potassium nitrate, cesium nitrate, silver nitrate, and the like. Examples of the sulfate include lithium sulfate, sodium sulfate, potassium sulfate, cesium sulfate, silver sulfate, and the like. Examples of the carbonate include lithium carbonate, sodium carbonate, potassium carbonate, and the like. Examples of the chloride include lithium chloride, sodium chloride, potassium chloride, cesium chloride, silver chloride, and the like. One of these molten salts may be used alone, or a plurality thereof may be used in combination.

In the present invention, the treatment conditions of the chemical strengthening treatment are not particularly limited, and appropriate conditions may be selected in consideration of the composition (properties) of the glass, the kind of the molten salt, desired chemical strengthening properties, and the like.

In the present invention, the chemical strengthening treatment may be performed only once, or may be performed a plurality of times under two or more different conditions (multistage strengthening). For example, a chemical strengthening treatment may be performed under a condition in which DOL is large and CS is relatively small as a chemical strengthening treatment as the first stage, and then a chemical strengthening treatment may be performed under a condition in which DOL is relatively small and CS is large as a chemical strengthening treatment as the second stage. In this case, the internal tensile stress area (St) can be reduced while increasing CS of the outermost surface of the chemically strengthened glass, and as a result, an absolute value of the internal tensile stress (CT) can be reduced.

### <Electronic Device>

The present chemically strengthened glass sheet is particularly useful as a cover glass used for a mobile electronic device such as a mobile phone, a smartphone, a personal digital assistant (PDA), and a tablet terminal. Further, the present chemically strengthened glass sheet is also useful for a cover glass of an electronic device such as a television (TV), a personal computer (PC), and a touch panel, which is not intended to be carried. In addition, the present chemically strengthened glass sheet is also useful as a building material such as a window glass, a table top, an interior of an automobile, an airplane, or the like, or a cover glass thereof.

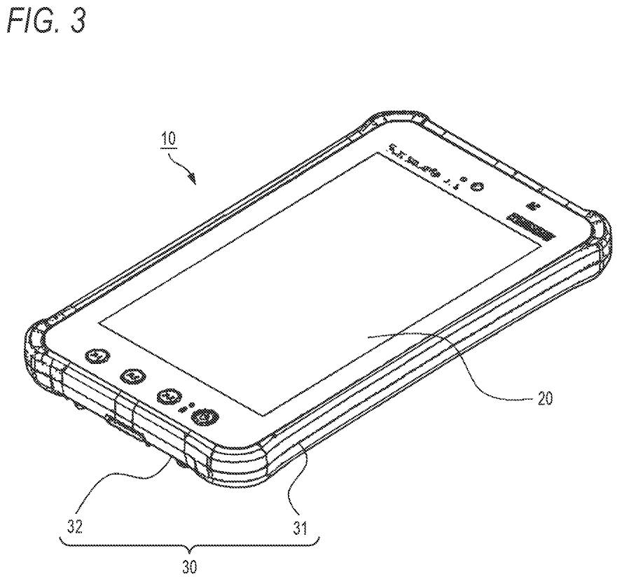

FIG. 3 shows an example of an electronic device including the present chemically strengthened glass sheet. A mobile terminal 10 shown in FIG. 3 includes a cover glass 20 and a housing 30. The housing 30 has a side surface 31 and a bottom surface 32. The present chemically strengthened glass sheet is used for both the cover glass 20 and the housing 30.

### EXAMPLES

Hereinafter, the present invention will be described with reference to Examples, but the present invention is not limited thereto. Examples 1 to 44 are Examples, and Examples 45 to 48 are Comparative Examples. For the measurement results in the table, a blank column indicates that the measurement is not performed.

### (Production of Glass)

Glass raw materials were blended so that a glass composition described in terms of mole percentage based on oxides in Tables 2 to 5 was obtained, and the glass raw materials were melted and polished to produce glasses (glass sheets) of Examples 1 to 48. As the glass raw materials, general glass raw materials such as an oxide, a hydroxide, and a carbonate were appropriately selected and weighed such that the glass has a weight of 900 g.

The mixed glass raw material was placed in a platinum crucible, melted at 1700° C., and defoamed. The glass was allowed to flow on a carbon board to obtain a glass block, and the glass block was polished to obtain a sheet-shaped glass having a sheet thickness of 0.7 mm. All of the glasses of Examples 1 to 48 were visually observed and no cloudiness was observed, and thus the glasses of Examples 1 to 48 were transparent glasses.

### (Fracture Toughness Value)

A sample having a size of 6.5 mm×6.5 mm×65 mm was prepared for the glass of each example, and a fracture toughness value was measured by the DCDC method. At this time, a through hole having a diameter of 2 mm was formed on a surface of the sample having a size of 65 mm×6.5 mm, and the evaluation was performed.

### (Young's Modulus and Poisson's Ratio)

The Young's modulus and the Poisson's ratio were measured by an ultrasonic method.

### (Glass Transition Point (Tg))

Apart of the obtained glass was pulverized in an agate mortar, and the glass transition point was measured using a differential scanning calorimeter (DSC3300SA, manufactured by Bruker Corporation). The amount of the sample used for the DSC measurement was about 60 mg, and the measurement was performed with the temperature being raised from room temperature to 1100° C. at a temperature rising rate of 10° C./min.

### (CT Limit)

The CT limit was evaluated by the method described above.

### (3D Formable Temperature)

A glass sheet having a size of 120 mm×60 mm×0.7 mm (thickness) was placed between an upper mold and a lower mold of a carbon mold including the upper mold and the lower mold, and the glass sheet and the carbon mold were placed in a heating furnace and heated to a predetermined temperature between 500° C. and 800° C. Next, a pressing load of 0.5 MPa was applied between the upper mold and the lower mold, followed by being held for 90 seconds for forming, and a shape was measured visually or by a contact type shape measuring device to determine whether a desired shape was obtained (forming test). In addition, the presence or absence of devitrification was determined by observation with a polarizing microscope.

The lowest temperature at which a desired shape was obtained and devitrification did not occur was defined as the formable temperature.

### (Haze Value)

Using a haze meter (HZ-V3, manufactured by Suga Test Instruments Co., Ltd.), the haze value (unit: %) under a halogen lamp C light source was measured in accordance with JIS K7136: 2000.

Only the glass of Example 2 was measured in terms of the haze value, but the haze value of the glasses of the other Examples was the same value.

### (Light Transmittance)

Regarding the light transmittance, the average transmittance for light having a wavelength of 380 to 780 nm was measured using a spectrophotometer UH410 manufactured by Hitachi, Ltd.

Only the glass of Example 2 was measured in terms of the light transmittance, but the light transmittance of the glasses of the other Examples was the same value.

### (Haze Difference Before and After Forming)

Haze values were measured before and after the forming test. The haze value was measured with a haze meter (HZ-V3, manufactured by Suga Test Instruments Co., Ltd.) using a halogen lamp C light source in accordance with JIS K7136: 2000.

When the glass sheet and the carbon mold adhere to each other during forming, the haze value of the glass sheet may increase. The difference between the haze values before and after forming (haze value (%) after forming−haze value (%) before forming) is shown in Tables 2 to 5 as “Haze deterioration (%) due to carbon”.

### (Devitrification Temperature)

A part of the glass was pulverized, and glass particles were put in a platinum vessel and heat-treated in an electric furnace controlled to a constant temperature within a range of 1000° C. to 1700° C. for 17 hours. The glass after the heat treatment was observed with a polarizing microscope, and the devitrification temperature was estimated by a method of observing the presence or absence of devitrification. In a vicinity of the devitrification temperature, the evaluation was performed at intervals of 10° C., and the highest temperature at which devitrification was observed was recorded as the devitrification temperature.

### (Devitrification Viscosity)

The devitrification viscosity was measured by using a rotary high-temperature viscometer while lowering the temperature from 1700° C. to 1000° C. (or until the viscosity started to rapidly increase due to devitrification) at 10° C./min, and a viscosity value at the above devitrification temperature was defined as the devitrification viscosity log 11.

### (Interparticle Distance)

The interparticle distance in the glass was analyzed by small-angle X-ray scattering (SAXS). The measurement conditions are shown below.

Device: synchrotron radiation, beamline “BL8S3”, small-angle X-ray scattering

Device location: 250-3 Minamiyamaguchi-cho, Seto, Aichi “Knowledge Hub Aichi” Aichi Science and Technology Foundation Aichi Synchrotron Radiation Center

Energy (wavelength): 0.92 Å

Measurement detector: PILATUS

Measurement time: 480 sec

Measurement camera length: 2180.9 mm

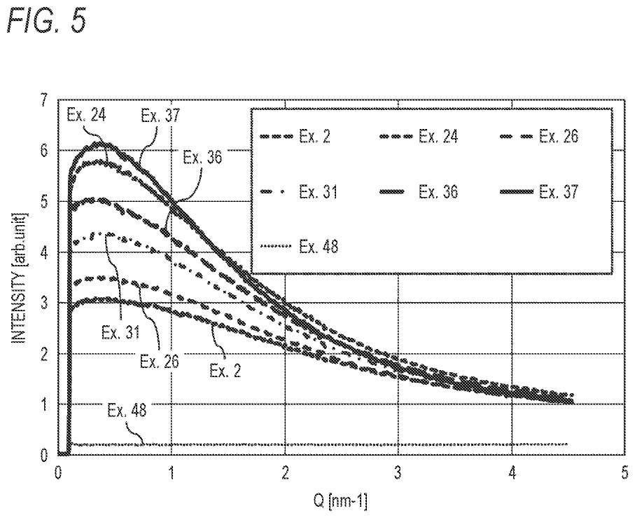

An example of the results obtained by the above measurement is shown in FIG. 5. Based on the obtained results, an interparticle distance I was obtained by the following formula.

I=2π/Qmax

Qmax is a value of Q (scattering vector) corresponding to an intensity peak of SAXS data having a clear peak in FIG. 5. The clear peak means, for example, a case where the peak intensity is five times or more as high as that of the baseline.

(Coordination Number of Al)

The coordination number of aluminum atoms in the glass was analyzed by ²⁷Al-NMR.

The measurement conditions of ²⁷Al-NMR are shown below.

Measurement device: Nuclear magnetic resonance device ECZ900 manufactured by Jeol Ltd.

Resonance frequency: 900 MHz

Number of revolutions: 20 kHz

Probe: for 3.2 mm solid

Flip angle: 30°

Pulse repetition waiting time: 1.5 Sec

The measurement was performed by a Single Pulse method under the above device and conditions, and α-Al₂O₃ was used as the secondary standard of the chemical shift to set at 16.6 ppm. For the measurement results, phase correction and baseline correction were performed using NMR software Delta manufactured by Jeol Ltd., and then fitting was performed using a Gaussian function to calculate the proportion of 4-coordinated Al, the proportion of 5-coordinated Al, and the proportion of 6-coordinated Al. The phase correction and the baseline correction are highly arbitrary, but the phase correction and the baseline correction are appropriately processed by subtracting a spectrum of an empty cell not including a sample. The peak fitting was also highly arbitrary, but good fitting was obtained by setting a peak top within a range of 80 to 45 ppm for the 4-coordinate, a peak top within a range of 45 to 15 ppm for the 5-coordinate, and a peak top in a range of 15 to 5 ppm for the 6-coordinate, and appropriately setting the peak width (so as to have a ratio of 1.5 times or less at the maximum between the respective coordination numbers). In order to quantitatively evaluate the coordination number of Al by the ²⁷Al MAS NMR spectrum, it is important to perform measurement in a high magnetic field (22.3 T or more).

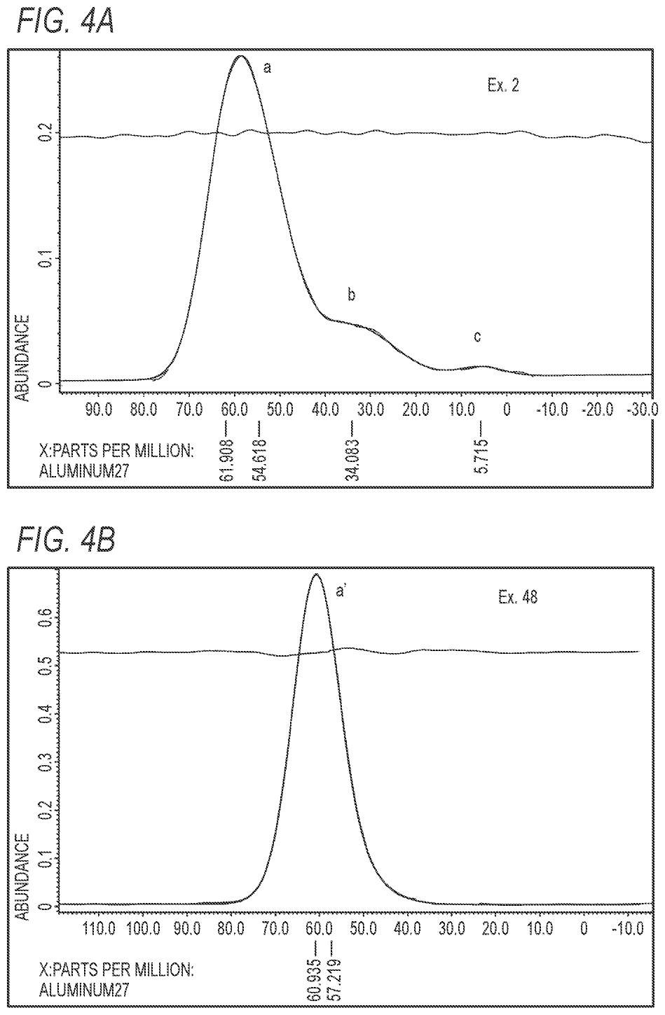

Here, FIG. 4A and FIG. 4B show an example of the measurement results of ²⁷Al-NMR. FIG. 4A is a diagram showing a ²⁷Al-NMR spectrum of the glass of Example 2, and FIG. 4B is a diagram showing a ²⁷Al-NMR spectrum of the glass of Example 48. In FIG. 4A, a peak a is attributed to 4-coordinated Al, a peak b is attributed to 5-coordinated Al, and a peak c is attributed to 6-coordinated Al. On the other hand, in FIG. 4B, a peak a′ attributed to 4-coordinated Al was observed, but peaks attributed to 5-coordinated Al and 6-coordinated Al were not observed.

(Coordination Number of B)

The proportion of the coordination number of the B atoms in the glass was measured using ECAII-700 manufactured by Jeol Ltd. owned by RIKEN (¹¹B-NMR measurement). The magnetic field intensity of ECAII-700 was 21.2 T (the resonance frequency of protons was 700 MHz), a probe dedicated to a 3.2 mm solid was used, and the number of revolutions was 15 kHz. B₂O₃ was measured as a standard sample and used as a secondary standard of chemical shift. All measurements were carried out by Single Pulse method.

Measurement device: Nuclear magnetic resonance device ECAII-700 manufactured by Jeol Ltd.

Resonance frequency: 700 MHz

Number of revolutions: 15 kHz

Probe: for 3.2 mm solid

Flip angle: 90°

Pulse repetition waiting time: 20 Sec

For the measurement results, phase correction and baseline correction were performed using NMR software Delta manufactured by Jeol Ltd., and then fitting was performed using a Gaussian function to calculate a proportion of 3-coordinated B and a proportion of 4-coordinated B.

TABLE 2

| | Example 1 | Example 2 | Example 3 | Example 4 | Example 5 | Example 6 | Example 7 |
|---|---|---|---|---|---|---|---|
| SiO₂ (mol %) | 55.0 | 57.0 | 49.0 | 52.0 | 49.0 | 49.0 | 49.0 |
| Al₂O₃ (mol %) | 22.5 | 22.5 | 28.5 | 27.5 | 27.5 | 27.5 | 28.5 |
| B₂O₃ (mol %) | 0.0 | 0.0 | 0.0 | 0.0 | 0.0 | 0.0 | 0.0 |
| P₂O₅ (mol %) | 5.1 | 3.1 | 5.1 | 5.1 | 5.1 | 8.1 | 5.1 |
| MgO (mol %) | 0.0 | 0.0 | 0.0 | 0.0 | 3.0 | 0.0 | 0.0 |
| ZnO (mol %) | 0.0 | 0.0 | 0.0 | 0.0 | 0.0 | 0.0 | 0.0 |
| CaO (mol %) | 0.0 | 0.0 | 0.0 | 0.0 | 0.0 | 0.0 | 0.0 |
| Y₂O₃ (mol %) | 5.3 | 5.3 | 5.3 | 3.3 | 3.3 | 3.3 | 3.3 |
| La₂O₃ (mol %) | 0.0 | 0.0 | 0.0 | 0.0 | 0.0 | 0.0 | 0.0 |
| ZrO₂ (mol %) | 2.0 | 2.0 | 2.0 | 2.0 | 2.0 | 2.0 | 2.0 |
| Li₂O (mol %) | 9.9 | 9.9 | 9.9 | 9.9 | 9.9 | 9.9 | 9.9 |
| Na₂O (mol %) | 0.2 | 0.2 | 0.2 | 0.2 | 0.2 | 0.2 | 2.2 |
| K₂O (mol %) | 0.0 | 0.0 | 0.0 | 0.0 | 0.0 | 0.0 | 0.0 |
| Total | 100.0 | 100.0 | 100.0 | 100.0 | 100.0 | 100.0 | 100.0 |
| SiO₂ + Al₂O₃ | 77.5 | 79.5 | 77.5 | 79.5 | 76.5 | 76.5 | 77.5 |
| [Li₂O]/[R₂O] | 1.0 | 1.0 | 1.0 | 1.0 | 1.0 | 1.0 | 0.8 |
| [Y₂O₃] + [La₂O₃] | 5.3 | 5.3 | 5.3 | 3.3 | 3.3 | 3.3 | 3.3 |
| [Al₂O₃]/[P₂O₅] | 4.4 | 7.3 | 5.6 | 5.4 | 5.4 | 3.4 | 5.6 |
| R₂O | 10.1 | 10.1 | 10.1 | 10.1 | 10.1 | 10.1 | 12.1 |
| RO | 0.0 | 0.0 | 0.0 | 0.0 | 3.0 | 0.0 | 0.0 |
| [Al₂O₃] − [R₂O] − | 7.3 | 9.3 | 13.3 | 12.3 | 9.3 | 9.3 | 11.3 |
| [RO] − [P₂O₅] | | | | | | | |
| Z = Σ + [Al₂O₃] − | 15.3 | 16.3 | 18.3 | 14.4 | 16.5 | 12.9 | 13.9 |
| [Li₂O] − [Na₂O] − | | | | | | | |
| [K₂O] − [P₂O₅] | | | | | | | |
| Fracture toughness | 0.92 | 0.93 | 0.93 | 0.92 | 0.90 | 0.87 | 0.92 |
| value (MPa · m^{1/2}) | | | | | | | |
| Young's modulus (GPa) | 96 | 97 | 102 | 97 | 94 | 89 | 93 |
| Poisson's ratio | 0.25 | 0.25 | 0.24 | 0.24 | 0.25 | 0.24 | 0.25 |
| CT limit (MPa) | 85 | 86 | 86 | 85 | 84 | 81 | 85 |
| 4-coordinated Al (%) | | 92 | | | | | |
| 5-coordinated Al (%) | | 8 | | | | | |
| 6-coordinated Al (%) | | 0.3 | | | | | |
| 3-coordinated B (%) | | | | | | | |
| 4-coordmated B (%) | | | | | | | |
| Interparticle distance (nm) | | 19 | | | | | |
| Intensity Max | | 3.1 | | | | | |
| Intensity Min | | 0.3 | | | | | |
| Tg (° C.) | 682 | 755 | 721 | 710 | 697 | 669 | 684 |
| 3D formable temperature | 690 | 720 | 730 | 720 | 710 | 680 | 700 |
| (° C.) | | | | | | | |
| Light transmittance (%) | | 90.5 | | | | | |
| Haze (%) | | 0.02 | | | | | |
| Haze deterioration | 0 | 0 | 0 | 0 | 0 | 0 | 0 |
| due to carbon (%) | | | | | | | |
| Devitrification | 1420 | 1400 | 1460 | 1480 | 1450 | 1420 | 1460 |
| temperature (° C.) | | | | | | | |
| Devitrification | 2.3 | 2.4 | 2.0 | 1.9 | 2.0 | 2.2 | 2.0 |
| viscosity log η | | | | | | | |

| | Example 8 | Example 9 | Example 10 | Example 11 | Example 12 |
|---|---|---|---|---|---|
| SiO₂ (mol %) | 52.0 | 52.0 | 52.0 | 49.0 | 49.0 |
| Al₂O₃ (mol %) | 25.5 | 23.5 | 22.5 | 23.5 | 22.5 |
| B₂O₃ (mol %) | 0.0 | 0.0 | 0.0 | 0.0 | 0.0 |
| P₂O₅ (mol %) | 5.1 | 5.1 | 5.1 | 8.1 | 8.1 |
| MgO (mol %) | 0.0 | 0.0 | 3.0 | 0.0 | 3.0 |
| ZnO (mol %) | 0.0 | 0.0 | 0.0 | 0.0 | 0.0 |
| CaO (mol %) | 0.0 | 0.0 | 0.0 | 0.0 | 0.0 |
| Y₂O₃ (mol %) | 5.3 | 7.3 | 5.3 | 7.3 | 5.3 |
| La₂O₃ (mol %) | 0.0 | 0.0 | 0.0 | 0.0 | 0.0 |
| ZrO₂ (mol %) | 2.0 | 2.0 | 2.0 | 2.0 | 2.0 |
| Li₂O (mol %) | 9.9 | 9.9 | 9.9 | 9.9 | 9.9 |
| Na₂O (mol %) | 0.2 | 0.2 | 0.2 | 0.2 | 0.2 |
| K₂O (mol %) | 0.0 | 0.0 | 0.0 | 0.0 | 0.0 |
| Total | 100.0 | 100.0 | 100.0 | 100.0 | 100.0 |
| SiO₂ + Al₂O₃ | 77.5 | 75.5 | 74.5 | 72.5 | 71.5 |
| [Li₂O]/[R₂O] | 1.0 | 1.0 | 1.0 | 1.0 | 1.0 |
| [Y₂O₃] + [La₂O₃] | 5.3 | 7.3 | 5.3 | 7.3 | 5.3 |
| [Al₂O₃]/[P₂O₅] | 5.0 | 4.6 | 4.4 | 2.9 | 2.8 |
| R₂O | 10.1 | 10.1 | 10.1 | 10.1 | 10.1 |
| RO | 0.0 | 0.0 | 3.0 | 0.0 | 3.0 |
| [Al₂O₃] − [R₂O] − | 10.3 | 8.3 | 4.3 | 5.3 | 1.3 |
| [RO] − [P₂O₅] | | | | | |
| Z = Σ + [Al₂O₃] − | 16.8 | 19.1 | 17.3 | 17.6 | 15.8 |
| [Li₂O] − [Na₂O] − | | | | | |
| [K₂O] − [P₂O₅] | | | | | |
| Fracture toughness | 0.94 | 0.93 | 0.89 | 0.91 | 0.89 |
| value (MPa · m^{1/2}) | | | | | |
| Young's modulus (GPa) | 91 | 102 | 90 | 100 | 96 |
| Poisson's ratio | 0.26 | 0.26 | 0.23 | 0.25 | 0.24 |
| CT limit (MPa) | 87 | 86 | 83 | 84 | 83 |
| 4-coordinated Al (%) | | | | | |
| 5-coordinated Al (%) | | | | | |
| 6-coordinated Al (%) | | | | | |
| 3-coordinated B (%) | | | | | |
| 4-coordmated B (%) | | | | | |
| Interparticle distance (nm) | | | | | |
| Intensity Max | | | | | |
| Intensity Min | | | | | |
| Tg (° C.) | 703 | 694 | 690 | 677 | 659 |
| 3D formable temperature | 710 | 710 | 700 | 690 | 670 |
| (° C.) | | | | | |
| Light transmittance (%) | | | | | |
| Haze (%) | | | | | |
| Haze deterioration | 0 | 0 | 0 | 0 | 0 |
| due to carbon (%) | | | | | |
| Devitrification | 1440 | 1460 | 1440 | 1500 | 1480 |
| temperature (° C.) | | | | | |
| Devitrification | 2.1 | 2.0 | 2.3 | 1.9 | 2.1 |
| viscosity log η | | | | | |

TABLE 3

| | Example 13 | Example 14 | Example 15 | Example 16 | Example 17 | Example 18 |
|---|---|---|---|---|---|---|
| SiO₂ (mol %) | 58.0 | 53.0 | 58.5 | 54.0 | 57.0 | 56.9 |
| Al₂O₃ (mol %) | 19.5 | 22.5 | 21.0 | 22.5 | 22.5 | 22.5 |
| B₂O₃ (mol %) | 0.0 | 0.0 | 0.0 | 3.0 | 0.0 | 0.0 |
| P₂O₅ (mol %) | 5.1 | 7.1 | 3.1 | 3.1 | 3.1 | 2.1 |
| MgO (mol %) | 0.0 | 0.0 | 0.0 | 0.0 | 0.0 | 0.0 |
| ZnO (mol %) | 0.0 | 0.0 | 0.0 | 0.0 | 0.0 | 0.0 |
| CaO (mol %) | 0.0 | 0.0 | 0.0 | 0.0 | 0.0 | 0.0 |
| Y₂O₃ (mol %) | 5.3 | 5.3 | 5.3 | 5.3 | 3.3 | 5.3 |
| La₂O₃ (mol %) | 0.0 | 0.0 | 0.0 | 0.0 | 2.0 | 0.0 |
| ZrO₂ (mol %) | 2.0 | 2.0 | 2.0 | 2.0 | 2.0 | 2.0 |
| Li₂O (mol %) | 9.9 | 9.9 | 9.9 | 9.9 | 9.9 | 11.0 |
| Na₂O (mol %) | 0.2 | 0.2 | 0.2 | 0.2 | 0.2 | 0.2 |
| K₂O (mol %) | 0.0 | 0.0 | 0.0 | 0.0 | 0.0 | 0.0 |
| Total | 100.0 | 100.0 | 100.0 | 100.0 | 100.0 | 100.0 |
| SiO₂ + Al₂O₃ | 77.5 | 75.5 | 79.5 | 76.5 | 79.5 | 79.4 |
| [Li₂O]/[R₂O] | 1.0 | 1.0 | 1.0 | 1.0 | 1.0 | 1.0 |
| [Y₂O₃] + [La₂O₃] | 5.3 | 5.3 | 5.3 | 5.3 | 5.3 | 5.3 |
| [Al₂O₃]/[P₂O₅] | 3.8 | 3.2 | 6.8 | 7.3 | 7.3 | 10.7 |
| R₂O | 10.1 | 10.1 | 10.1 | 10.1 | 10.1 | 11.2 |
| RO | 0.0 | 0.0 | 0.0 | 0.0 | 0.0 | 0.0 |
| [Al₂O₃] − [R₂O] − | 4.3 | 5.3 | 7.8 | 9.3 | 9.3 | 9.2 |
| [RO] − [P₂O₅] | | | | | | |
| Z = Σ + [Al₂O₃] − | 13.8 | 14.3 | 15.5 | 16.3 | 15.8 | 16.2 |
| [Li₂O] − [Na₂O] − | | | | | | |
| [K₂O] − [P₂O₅] | | | | | | |
| Fracture toughness | 0.86 | 0.91 | 0.89 | 0.89 | 0.90 | 0.91 |
| value (MPa · m^{1/2}) | | | | | | |
| Young's modulus (GPa) | 89 | 93 | 96 | 96 | 97 | 98 |
| Poisson's ratio | 0.25 | 0.25 | 0.25 | 0.25 | 0.25 | 0.25 |
| CT limit (MPa) | 80 | 84 | 87 | 87 | 88 | 89 |
| 4-coordinated Al (%) | | | | | | |
| 5-coordinated Al (%) | | | | | | |
| 6-coordinated Al (%) | | | | | | |
| 3-coordinated B (%) | | | | 96 | | |
| 4-coordmated B (%) | | | | 4 | | |
| Interparticle distance (nm) | | | | | | |
| Intensity Max | | | | | | |
| Intensity Min | | | | | | |
| Tg (° C.) | 673 | 685 | 718 | 753 | 737 | 747 |
| 3D formable temperature | 680 | 700 | 725 | 768 | 708 | 725 |
| (° C.) | | | | | | |
| Light transmittance (%) | | | | | | |
| Haze (%) | | | | | | |
| Haze deterioration | 0 | 0 | 0 | 0 | 0 | 0 |
| due to carbon (%) | | | | | | |
| Devitrification | 1390 | 1420 | 1430 | 1420 | 1450 | 1440 |
| temperature (° C.) | | | | | | |
| Devitrification | 2.5 | 2.3 | | 2.3 | | |
| viscositv log η | | | | | | |
| | Example 19 | Example 20 | Example 21 | Example 22 | Example 23 | Example 24 |
| SiO₂ (mol %) | 57.0 | 57.0 | 57.0 | 57.0 | 57.0 | 57.0 |
| Al₂O₃ (mol %) | 22.5 | 22.5 | 22.5 | 22.5 | 22.5 | 22.5 |
| B₂O₃ (mol %) | 0.0 | 3.0 | 5.3 | 0.0 | 0.0 | 0.0 |
| P₂O₅ (mol %) | 3.1 | 3.1 | 3.1 | 3.1 | 2.1 | 0.0 |
| MgO (mol %) | 0.0 | 0.0 | 0.0 | 3.0 | 0.0 | 0.0 |
| ZnO (mol %) | 0.0 | 0.0 | 0.0 | 0.0 | 0.0 | 0.0 |
| CaO (mol %) | 0.0 | 0.0 | 0.0 | 0.0 | 0.0 | 0.0 |
| Y₂O₃ (mol %) | 2.3 | 2.3 | 0.0 | 2.3 | 5.3 | 5.3 |
| La₂O₃ (mol %) | 3.0 | 0.0 | 0.0 | 0.0 | 0.0 | 0.0 |
| ZrO₂ (mol %) | 2.0 | 2.0 | 2.0 | 2.0 | 2.0 | 2.0 |
| Li₂O (mol %) | 9.9 | 9.9 | 9.9 | 9.9 | 9.9 | 9.9 |
| Na₂O (mol %) | 0.2 | 0.2 | 0.2 | 0.2 | 1.2 | 3.3 |
| K₂O (mol %) | 0.0 | 0.0 | 0.0 | 0.0 | 0.0 | 0.0 |
| Total | 100.0 | 100.0 | 100.0 | 100.0 | 100.0 | 100.0 |
| SiO₂ + Al₂O₃ | 79.5 | 79.5 | 79.5 | 79.5 | 79.5 | 79.5 |
| [Li₂O]/[R₂O] | 1.0 | 1.0 | 1.0 | 1.0 | 0.9 | 0.8 |
| [Y₂O₃] + [La₂O₃] | 5.3 | 2.3 | 0.0 | 2.3 | 5.3 | 5.3 |
| [Al₂O₃]/[P₂O₅] | 7.3 | 7.3 | 7.3 | 7.3 | 10.7 | — |
| R₂O | 10.1 | 10.1 | 10.1 | 10.1 | 11.1 | 13.2 |
| RO | 0.0 | 0.0 | 0.0 | 3.0 | 0.0 | 0.0 |
| [Al₂O₃] − [R₂O] − | 9.3 | 9.3 | 9.3 | 6.3 | 9.3 | 9.3 |
| [RO] − [P₂O₅] | | | | | | |
| Z = Σ + [Al₂O₃] − | 15.6 | 11.3 | 7.4 | 13.3 | 16.3 | 16.3 |
| [Li₂O] − [Na₂O] − | | | | | | |
| [K₂O] − [P₂O₅] | | | | | | |
| Fracture toughness | 0.89 | 0.84 | 0.83 | 0.88 | 0.91 | 0.92 |
| value (MPa · m^{1/2}) | | | | | | |
| Young's modulus (GPa) | 96 | 91 | 90 | 95 | 98 | 99 |
| Poisson's ratio | 0.25 | 0.25 | 0.25 | 0.24 | 0.25 | 0.25 |
| CT limit (MPa) | 87 | 82 | 81 | 86 | 89 | 90 |
| 4-coordinated Al (%) | | | 89 | | | 96 |
| 5-coordinated Al (%) | | | 11 | | | 4 |
| 6-coordinated Al (%) | | | | | | |
| 3-coordinated B (%) | | 99 | 99 | | | |
| 4-coordmated B (%) | | 1 | 1 | | | |
| Interparticle distance (nm) | | | | | | 17 |
| Intensity Max | | | | | | 5.8 |
| Intensity Min | | | | | | 0.4 |
| Tg (° C.) | 744 | 744 | 759 | 707 | 721 | 713 |
| 3D formable temperature | 744 | 774 | 767 | 693 | 692 | 706 |
| (° C.) | | | | | | |
| Light transmittance (%) | | | | | | |
| Haze (%) | | | | | | |
| Haze deterioration | 0 | 0 | 0 | 0 | 0 | 0 |
| due to carbon (%) | | | | | | |
| Devitrification | 1420 | 1410 | 1430 | 1430 | 1430 | 1400 |
| temperature (° C.) | | | | | | |
| Devitrification | | | | | | 2.3 |
| viscositv log η | | | | | | |

TABLE 4

| | Example 25 | Example 26 | Example 27 | Example 28 | Example 29 | Example 30 |
|---|---|---|---|---|---|---|
| SiO₂ (mol %) | 57.0 | 55.0 | 55.0 | 55.0 | 55.0 | 55.0 |
| Al₂O₃ (mol %) | 20.5 | 22.5 | 22.5 | 22.5 | 22.5 | 22.5 |
| B₂O₃ (mol %) | 2.0 | 2.0 | 2.0 | 2.0 | 2.0 | 4.1 |
| P₂O₅ (mol %) | 2.1 | 2.1 | 2.1 | 2.1 | 2.1 | 0.0 |
| MgO (mol %) | 0.0 | 0.0 | 0.0 | 0.0 | 0.0 | 0.0 |
| ZnO (mol %) | 0.0 | 0.0 | 0.0 | 0.0 | 0.0 | 0.0 |
| CaO (mol %) | 0.0 | 0.0 | 0.0 | 0.0 | 0.0 | 0.0 |
| Y₂O₃ (mol %) | 5.3 | 5.3 | 2.7 | 4.3 | 2.2 | 2.7 |
| La₂O₃ (mol %) | 0.0 | 0.0 | 2.6 | 0.0 | 2.1 | 2.6 |
| ZrO₂ (mol %) | 2.0 | 2.0 | 2.0 | 3.0 | 3.0 | 2.0 |
| Li₂O (mol %) | 9.9 | 9.9 | 9.9 | 9.9 | 9.9 | 9.9 |
| Na₂O (mol %) | 1.2 | 1.2 | 1.2 | 1.2 | 1.2 | 1.2 |
| K₂O (mol %) | 0.0 | 0.0 | 0.0 | 0.0 | 0.0 | 0.0 |
| Total | 100.0 | 100.0 | 100.0 | 100.0 | 100.0 | 100.0 |
| SiO₂ + Al₂O₃ | 77.5 | 77.5 | 77.5 | 77.5 | 77.5 | 77.5 |
| [Li₂O]/[R₂O] | 0.9 | 0.9 | 0.9 | 0.9 | 0.9 | 0.9 |
| [Y₂O₃] + [La₂O₃] | 5.3 | 5.3 | 5.3 | 4.3 | 4.3 | 5.3 |
| [Al₂O₃]/[P₂O₅] | 9.8 | 10.7 | 10.7 | 10.7 | 10.7 | — |
| R₂O | 11.1 | 11.1 | 11.1 | 11.1 | 11.1 | 11.1 |
| RO | 0.0 | 0.0 | 0.0 | 0.0 | 0.0 | 0.0 |
| [Al₂O₃] − [R₂O] − | 7.3 | 9.3 | 9.3 | 9.3 | 9.3 | 11.4 |
| [RO] − [P₂O₅] | | | | | | |
| Z = Σ + [Al₂O₃] − | 15.3 | 16.3 | 15.7 | 16.0 | 15.5 | 16.8 |
| [Li₂O] − [Na₂O] − | | | | | | |
| [K₂O] − [P₂O₅] | | | | | | |
| Fracture toughness | 0.89 | 0.93 | 0.89 | 0.90 | 0.88 | 0.90 |
| value (MPa · m^{1/2}) | | | | | | |
| Young's modulus (GPa) | 96 | 100 | 96 | 97 | 95 | 97 |
| Poisson's ratio | 0.25 | 0.25 | 0.26 | 0.26 | 0.26 | 0.26 |
| CT limit (MPa) | 87 | 91 | 87 | 88 | 86 | 88 |
| 4-coordinated Al (%) | | 97 | | | | 95 |
| 5-coordinated Al (%) | | 3 | | | | 5 |
| 6-coordinated Al (%) | | | | | | |
| 3-coordinated B (%) | | 99 | | | | |
| 4-coordmated B (%) | | 1 | | | | |
| Interparticle distance (nm) | | 18 | | | | |
| Intensity Max | | 3.5 | | | | |
| Intensity Min | | 0.3 | | | | |
| Tg (° C.) | 733 | 740 | 758 | 747 | 761 | 720 |
| 3D formable temperature | 696 | 747 | 735 | 762 | 769 | 742 |
| (° C.) | | | | | | |
| Light transmittance (%) | | | | | | |
| Haze (%) | | | | | | |
| Haze deterioration | 0 | 0 | 0 | 0 | 0 | 0 |
| due to carbon (%) | | | | | | |
| Devitrification | 1410 | 1390 | 1380 | 1430 | 1420 | 1370 |
| temperature (° C.) | | | | | | |
| Devitrification | | 2.4 | | | | |
| viscosity log η | | | | | | |
| | Example 31 | Example 32 | Example 33 | Example 34 | Example 35 | Example 36 |
| SiO₂ (mol %) | 55.0 | 55.1 | 56.0 | 56.1 | 58.0 | 59.5 |
| Al₂O₃ (mol %) | 22.5 | 23.5 | 22.5 | 23.5 | 22.5 | 21.0 |
| B₂O₃ (mol %) | 4.1 | 2.0 | 4.1 | 2.0 | 0.0 | 0.0 |
| P₂O₅ (mol %) | 0.0 | 0.0 | 0.0 | 0.0 | 0.0 | 0.0 |
| MgO (mol %) | 0.0 | 0.0 | 0.0 | 0.0 | 0.0 | 0.0 |
| ZnO (mol %) | 0.0 | 0.0 | 0.0 | 0.0 | 0.0 | 0.0 |
| CaO (mol %) | 0.0 | 0.0 | 0.0 | 0.0 | 0.0 | 0.0 |
| Y₂O₃ (mol %) | 5.3 | 5.3 | 5.3 | 5.3 | 5.3 | 5.3 |
| La₂O₃ (mol %) | 0.0 | 0.0 | 0.0 | 0.0 | 0.0 | 0.0 |
| ZrO₂ (mol %) | 2.0 | 2.0 | 1.0 | 1.0 | 1.0 | 1.0 |
| Li₂O (mol %) | 9.9 | 9.9 | 9.9 | 9.9 | 9.9 | 9.9 |
| Na₂O (mol %) | 1.2 | 2.2 | 1.2 | 2.2 | 3.3 | 3.3 |
| K₂O (mol %) | 0.0 | 0.0 | 0.0 | 0.0 | 0.0 | 0.0 |
| Total | 100.0 | 100.0 | 100.0 | 100.0 | 100.0 | 100.0 |
| SiO₂ + Al₂O₃ | 77.5 | 78.6 | 78.5 | 79.6 | 80.5 | 80.5 |
| [Li₂O]/[R₂O] | 0.9 | 0.8 | 0.9 | 0.8 | 0.8 | 0.8 |
| [Y₂O₃] + [La₂O₃] | 5.3 | 5.3 | 5.3 | 5.3 | 5.3 | 5.3 |
| [Al₂O₃]/[P₂O₅] | — | — | — | — | — | — |
| R₂O | 11.1 | 12.1 | 11.1 | 12.1 | 13.2 | 13.2 |
| RO | 0.0 | 0.0 | 0.0 | 0.0 | 0.0 | 0.0 |
| [Al₂O₃] − [R₂O] − | 11.4 | 11.4 | 11.4 | 11.4 | 9.3 | 7.8 |
| [RO] − [P₂O₅] | | | | | | |
| Z = Σ + [Al₂O₃] − | 17.3 | 17.3 | 15.9 | 15.9 | 14.9 | 14.1 |
| [Li₂O] − [Na₂O] − | | | | | | |
| [K₂O] − [P₂O₅] | | | | | | |
| Fracture toughness | 0.93 | 0.93 | 0.91 | 0.93 | 0.91 | 0.91 |
| value (MPa · m^{1/2}) | | | | | | |
| Young's modulus (GPa) | 100 | 100 | 98 | 101 | 98 | 98 |
| Poisson's ratio | 0.26 | 0.26 | 0.26 | 0.26 | 0.25 | 0.25 |
| CT limit (MPa) | 91 | 91 | 89 | 91 | 89 | 89 |
| 4-coordinated Al (%) | 94 | | | | | 98 |
| 5-coordinated Al (%) | 6 | | | | | 2 |
| 6-coordinated Al (%) | | | | | | |
| 3-coordinated B (%) | 95 | | | | | |
| 4-coordmated B (%) | 5 | | | | | |
| Interparticle distance (nm) | 50 | | | | | 15 |
| Intensity Max | 4.4 | | | | | 5.0 |
| Intensity Min | 0.4 | | | | | 0.3 |
| Tg (° C.) | 787 | 754 | 777 | 745 | 705 | 699 |
| 3D formable temperature | 771 | 785 | 785 | 708 | 705 | 671 |
| (° C.) | | | | | | |
| Light transmittance (%) | | | | | | |
| Haze (%) | | | | | | |
| Haze deterioration | 0 | 0 | 0 | 0 | 0 | 0 |
| due to carbon (%) | | | | | | |
| Devitrification | 1380 | 1400 | 1380 | 1400 | 1380 | 1325 |
| temperature (° C.) | | | | | | |
| Devitrification | 2.3 | | | | | 2.7 |
| viscosity log η | | | | | | |

TABLE 5

| | Example 37 | Example 38 | Example 39 | Example 40 | Example 41 | Example 42 |
|---|---|---|---|---|---|---|
| SiO₂ (mol %) | 55.4 | 57.5 | 60.5 | 56.4 | 55.4 | 57.4 |
| Al₂O₃ (mol %) | 21.0 | 21.0 | 20.0 | 20.0 | 20.0 | 20.0 |
| B₂O₃ (mol %) | 4.1 | 4.1 | 0.0 | 4.1 | 4.1 | 4.1 |
| P₂O₅ (mol %) | 0.0 | 0.0 | 0.0 | 0.0 | 0.0 | 0.0 |
| MgO (mol %) | 0.0 | 0.0 | 0.0 | 0.0 | 0.0 | 0.0 |
| ZnO (mol %) | 0.0 | 0.0 | 0.0 | 0.0 | 0.0 | 0.0 |
| CaO (mol %) | 0.0 | 0.0 | 0.0 | 0.0 | 0.0 | 0.0 |
| Y₂O₃ (mol %) | 5.3 | 3.3 | 5.3 | 5.3 | 5.3 | 5.3 |
| La₂O₃ (mol %) | 0.0 | 0.0 | 0.0 | 0.0 | 0.0 | 0.0 |
| ZrO₂ (mol %) | 1.0 | 1.0 | 1.0 | 1.0 | 1.0 | 0.0 |
| Li₂O (mol %) | 9.9 | 9.9 | 9.9 | 9.9 | 9.9 | 9.9 |
| Na₂O (mol %) | 3.3 | 3.2 | 3.3 | 3.3 | 4.3 | 3.3 |
| K₂O (mol %) | 0.0 | 0.0 | 0.0 | 0.0 | 0.0 | 0.0 |
| Total | 100.0 | 100.0 | 100.0 | 100.0 | 100.0 | 100.0 |
| SiO₂ + Al₂O₃ | 76.4 | 78.5 | 80.5 | 76.4 | 75.4 | 77.4 |
| [Li₂O]/[R₂O] | 0.8 | 0.8 | 0.8 | 0.8 | 0.7 | 0.8 |
| [Y₂O₃] + [La₂O₃] | 5.3 | 3.3 | 5.3 | 5.3 | 5.3 | 5.3 |
| [Al₂O₃]/[P₂O₅] | — | — | — | — | — | — |
| R₂O | 13.2 | 13.1 | 13.2 | 13.2 | 14.2 | 13.2 |
| RO | 0.0 | 0.0 | 0.0 | 0.0 | 0.0 | 0.0 |
| [Al₂O₃] − [R₂O] − | 7.8 | 7.9 | 6.8 | 6.8 | 5.8 | 6.8 |
| [RO] − [P₂O₅] | | | | | | |
| Z = Σ + [Al₂O₃] − | 14.1 | 10.8 | 13.6 | 13.6 | 13.1 | 12.2 |
| [Li₂O] − [Na₂O] − | | | | | | |
| [K₂O] − [P₂O₅] | | | | | | |
| Fracture toughness | 0.88 | 0.85 | 0.90 | 0.88 | 0.87 | 0.87 |
| value (MPa · m^{1/2}) | | | | | | |
| Young's modulus (GPa) | 95 | 92 | 97 | 95 | 94 | 94 |
| Poisson's ratio | 0.25 | 0.25 | 0.25 | 0.25 | 0.25 | 0.25 |
| CT limit (MPa) | 86 | 83 | 88 | 86 | 85 | 86 |
| 4-coordinated Al (%) | 98 | 99 | | | | |
| 5-coordinated Al (%) | 2 | 1 | | | | |
| 6-coordinated Al (%) | | | | | | |
| 3-coordinated B (%) | 96 | 96 | | | | |
| 4-coordmated B (%) | 4 | 4 | | | | |
| Interparticle distance (nm) | 15 | | | | | |
| Intensity Max | 6.1 | | | | | |
| Intensity Min | 0.3 | | | | | |
| Tg (° C.) | 739 | 735 | 696 | 736 | 720 | 726 |
| 3D formable temperature | 717 | 698 | 675 | 706 | 713 | 748 |
| (° C.) | | | | | | |
| Light transmittance (%) | | | | | | |
| Haze (%) | | | | | | |
| Haze deterioration | 0 | 0 | 0 | 0 | 0 | 0 |
| due to carbon (%) | | | | | | |
| Devitrification | 1300 | 1375 | 1275 | 1275 | 1275 | 1250 |
| temperature (° C.) | | | | | | |
| Devitrification | 2.6 | | | | | |
| viscosity log η | | | | | | |
| | Example 43 | Example 44 | Example 45 | Example 46 | Example 47 | Example 48 |
| SiO₂ (mol %) | 57.4 | 61.5 | 70.0 | 53.6 | 49.0 | 57.5 |
| Al₂O₃ (mol %) | 19.0 | 19.0 | 7.5 | 32.1 | 30.5 | 18.1 |
| B₂O₃ (mol %) | 4.1 | 0.0 | 0.0 | 0.0 | 0.0 | 6.0 |
| P₂O₅ (mol %) | 0.0 | 0.0 | 0.02 | 0.0 | 5.1 | 0.0 |
| MgO (mol %) | 0.0 | 0.0 | 7.0 | 0.0 | 0.0 | 4.3 |
| ZnO (mol %) | 0.0 | 0.0 | 0.0 | 0.0 | 0.0 | 0.0 |
| CaO (mol %) | 0.0 | 0.0 | 0.2 | 0.0 | 0.0 | 0.5 |
| Y₂O₃ (mol %) | 5.3 | 5.3 | 0.0 | 3.6 | 3.3 | 0.0 |
| La₂O₃ (mol %) | 0.0 | 0.0 | 0.0 | 0.0 | 0.0 | 0.0 |
| ZrO₂ (mol %) | 1.0 | 1.0 | 1.0 | 0.0 | 2.0 | 0.0 |
| Li₂O (mol %) | 9.9 | 9.9 | 8.0 | 10.7 | 9.9 | 10.5 |
| Na₂O (mol %) | 3.3 | 3.3 | 5.3 | 0.0 | 0.2 | 3.1 |
| K₂O (mol %) | 0.0 | 0.0 | 1.0 | 0.0 | 0.0 | 0.0 |
| Total | 100.0 | 100.0 | 100.0 | 100.0 | 100.0 | 100.0 |
| SiO₂ + Al₂O₃ | 76.4 | 80.5 | 77.5 | 85.7 | 79.5 | 75.6 |
| [Li₂O]/[R₂O] | 0.8 | 0.8 | 0.6 | 1.0 | 1.0 | 0.8 |
| [Y₂O₃] + [La₂O₃] | 5.3 | 5.3 | 0.0 | 3.6 | 3.3 | 0.0 |
| [Al₂O₃]/[P₂O₅] | — | — | 375.0 | — | 6.0 | — |
| R₂O | 13.2 | 13.2 | 14.3 | 10.7 | 10.1 | 13.6 |
| RO | 0.0 | 0.0 | 7.2 | 0.0 | 0.0 | 4.8 |
| [Al₂O₃] − [R₂O] − | 5.8 | 5.8 | −14.0 | 21.4 | 15.3 | −0.3 |
| [RO] − [P₂O₅] | | | | | | |
| Z = Σ + [Al₂O₃] − | 13.1 | 13.1 | 4.8 | 16.7 | 15.9 | 5.5 |
| [Li₂O] − [Na₂O] − | | | | | | |
| [K₂O] − [P₂O₅] | | | | | | |
| Fracture toughness | 0.87 | 0.90 | 0.80 | 0.97 | 0.94 | 0.84 |
| value (MPa · m^{1/2}) | | | | | | |
| Young's modulus (GPa) | 94 | 97 | 83 | 105 | 99 | 84 |
| Poisson's ratio | 0.25 | 0.25 | 0.22 | 0.26 | 0.25 | 0.24 |
| CT limit (MPa) | 85 | 88 | 74 | 90 | | 79 |
| 4-coordinated Al (%) | 95 | | 100 | | | 100 |
| 5-coordinated Al (%) | 5 | | 0 | | | |
| 6-coordinated Al (%) | | | | | | |
| 3-coordinated B (%) | 96 | | | | | 98 |
| 4-coordmated B (%) | 4 | | | | | 2 |
| Interparticle distance (nm) | | | | | | — |
| Intensity Max | | | | | | 0.4 |
| Intensity Min | | | | | | 0.3 |
| Tg (° C.) | 732 | 692 | 548 | 760 | 732 | 603 |
| 3D formable temperature | 710 | 706 | 600 | 770 | 740 | |
| (° C.) | | | | | | |
| Light transmittance (%) | | | | | | |
| Haze (%) | | | | | | |
| Haze deterioration | 0 | 0 | 0 | 10 | 5 | 0 |
| due to carbon (%) | | | | | | |
| Devitrification | 1300 | 1325 | 1100 | 1560 | 1530 | 1250 |
| temperature (° C.) | | | | | | |
| Devitrification | | | 4.5 | 1.3 | 1.7 | 3.0 |
| viscosity log η | | | | | | |

### (Chemical Strengthening Treatment)

Glass sheets each having a thickness of 700 μm made of the glasses of Examples 1, 2, 45, and 46 shown in Tables 2 and 5 were chemically strengthened to obtain chemically strengthened glasses of Examples 51 to 54. In the chemical strengthening, ion exchange was performed under the first conditions (strengthening salt, temperature, treatment time) shown in Table 6, and then ion exchange was performed under the second conditions shown in Table 6. Each of the obtained chemically strengthened glasses of Examples 51 to 54 was processed into a size of 0.3 mm×20 mm, and a stress profile was measured using a birefringence stress meter (birefringence imaging system Abrio-IM manufactured by CRi Corporation). As an example, a stress profile of the chemically strengthened glass of Example 2 is shown in FIG. 2. In addition, regarding the chemically strengthened glasses of Examples 51 to 54, the fragmentation number was measured by the method described above in the section of the measurement method of the CT limit.

TABLE 6

| | Example 51 | Example 52 | Example 53 | Example 54 |
|---|---|---|---|---|
| Glass | Example 1 | Example 2 | Example 45 | Example 46 |
| Sheet thickness (μm) | 700 | 700 | 700 | 700 |
| First strengthening salt | NaNO₃ | NaNO₃ | NaNO₃ | NaNO₃ |
| First temperature (° C.) | 450 | 450 | 450 | 450 |
| First treatment time (hr) | 6 | 7 | 4 | 14 |
| Second strengthening salt | No | No | KNO₃ | No |
| Second temperature (° C.) | | | 415 | |
| Second treatment time (hr) | | | 2.5 | |
| DOL (μm) | 92 | 90 | 158 | 71 |
| Surface compressive stress (MPa) | 652 | 712 | 909 | 936 |
| Compressive stress at depth of 50 | 217 | 220 | 98 | 198 |
| μm (MPa) | | | | |
| Internal tensile stress (MPa) | −83 | −85 | −57 | −90 |
| Fragmentation number | 8 | 7 | 6 | 6 |

The chemically strengthened glasses of Examples 51 and 52 (glasses of Examples 1 and 2) which were Inventive Examples were chemically strengthened glasses not only having a large surface compressive stress caused by chemical strengthening but also having a large compressive stress at a depth of 50 μm as compared with Comparative Examples. In such a chemically strengthened glass, not only bending fracture is less likely to occur, but also fracture caused by collision is less likely to occur.

The chemically strengthened glass of Example 54 (glass of Example 46) having an excessively high Al₂O₃ content is not easy to manufacture because of a high devitrification temperature thereof. In addition, in the glass of Example 46, an increase in the haze value was observed after the forming test, and the 3D moldability was poor. The DOL of the glass of Example 46 was not so large even when the chemical strengthening treatment was performed for a long time (Example 54).

The chemically strengthened glass of Example 53 (glass of Example 45), which is a conventional glass for chemical strengthening, has a relatively small CT limit. Therefore, it is considered that when the surface compressive stress is increased, the compressive stress value at a depth of 50 μm is decreased or the fragmentation number is increased.

Although the present invention has been described in detail with reference to specific embodiments, it is apparent to those skilled in the art that various changes and modifications can be made without departing from the spirit and scope of the present invention. The present application is based on a Japanese Patent Application (No. 2020-080385) filed on Apr. 30, 2020, the contents of which are incorporated herein by reference.

### REFERENCE SIGNS LIST

10 Mobile terminal
20 Cover glass
30 Housing
31 Side Surface
32 Bottom surface

1. A glass comprising, in terms of mole percentage based on oxides:
SiO₂ in an amount of 45% to 65%;
Al₂O₃ in an amount of 18% to 30%;
Li₂O in an amount of 7% to 15%;
one or more selected from Y₂O₃ and La₂O₃ in a total amount of 0% to 10%;
P₂O₅ in an amount of 0% to 10%;
B₂O₃ in an amount of 0% to 10%; and
ZrO₂ in an amount of 0% to 4%, and
satisfying the following expression:
[Al₂O₃]—[R₂O]—[RO]—[P₂O₅]>0
provided that, in terms of mole percentage based on oxides, a content of Al₂O₃ is defined as [Al₂O₃], a content of P₂O₅ is defined as [P₂O₅], a total content of alkali metal oxides is defined as [R₂O], and a total content of alkali earth metal oxides is defined as [RO].

2. A glass comprising, in terms of mole percentage based on oxides:
SiO₂ in an amount of 45% to 65%;
Al₂O₃ in an amount of 18% to 30%;
Li₂O in an amount of 7% to 15%;
one or more selected from Y₂O₃ and La₂O₃ in a total amount of 2% to 10%;
P₂O₅ in an amount of 2% to 10%; and
ZrO₂ in an amount of 0% to 4%, and
having a ratio [Al₂O₃]/[P₂O₅] of an Al₂O₃ content to a P₂O₅ content of 2.5 to 13.

3. The glass according to claim 1, having a ratio [Li₂O]/[R₂O] of 0.7 to 1, provided that, in terms of mole percentage based on oxides, a content of Li₂O is defined as [Li₂O], and the total content of alkali metal oxides is defined as [R₂O].

4. The glass according to claim 1, having a fracture toughness value of 0.85 MPa·m^{1/2} or more.

5. The glass according to claim 1, having an interparticle distance of particles present in the glass, which is determined by small-angle X-ray scattering (SAXS) measurement, of 2 nm to 100 nm.

6. The glass according to claim 1, having a proportion of a total number of 5-coordinated aluminum atoms and 6-coordinated aluminum atoms to a total number of aluminum atoms in the glass of 1% or more and 15% or less.

7. The glass according to claim 1, having a Young's modulus of 85 GPa or more.

8. The glass according to claim 1, comprising an arbitrary oxide MₓO_{y} (x and y are positive integers) other than SiO₂, B₂O₃, Al₂O₃, Li₂O, Na₂O, K₂O, and P₂O₅, and having Z represented by the following Formula (1) of 5 to 100:
Z=Σ+[Al₂O₃]—[Li₂O]—[Na₂O]—[K₂O]—[P₂O₅] Formula (1)
provided that a content of MₓO_{y} in terms of mole percentage is defined as [MₓO_{y}], an ionic radius of M is defined as r(M), and the sum of (2y/x)/r(M)×[MₓO_{y})]×2/x is defined as Σ.

9. The glass according to claim 1, having a devitrification temperature of 1500° C. or lower.

10. The glass according to claim 1, wherein in a case where the glass is chemically strengthened and a fragmentation number is measured by the following method, a maximum value of an absolute value of an internal tensile stress value (CT) at which the fragmentation number is 10 or less is 75 MPa or more.
(Method of Measuring Fragmentation number)
As a test glass sheet, a glass sheet having a 15 mm square and a thickness of 0.7 mm and having a mirror-finished surface is prepared; the test glass sheet is chemically strengthened under various conditions to prepare a plurality of test glass sheets having different CT values; and the CT value in this case is measured using a scattered light photoelastic stress meter,
using a Vickers tester, a diamond indenter with a tip angle of 90° is driven into a central portion of the test glass sheet to fracture the glass sheet, and the number of broken pieces of the test glass sheet is defined as the fragmentation number; the test is initiated with a driving load of a diamond indenter of 3 kgf and in a case where a glass sheet is not cracked, the driving load is increased by 1 kgf each time; and the test is repeated until the glass sheet is cracked, and the number of broken pieces when the glass sheet is cracked for the first time is counted as the fragmentation number.

11. A chemically strengthened glass having a base composition comprising, in terms of mole percentage based on oxides:
SiO₂ in an amount of 45% to 65%;
Al₂O₃ in an amount of 18% to 30%;
Li₂O in an amount of 7% to 15%;
one or more selected from Y₂O₃ and La₂O₃ in a total amount of 0% to 10%;
P₂O₅ in an amount of 0% to 10%;
B₂O₃ in an amount of 0% to 10%; and
ZrO₂ in an amount of 0% to 4%,
satisfying the following expression:
[Al₂O₃]—[R₂O]—[RO]—[P₂O₅]>0
provided that, in terms of mole percentage based on oxides, a content of Al₂O₃ is defined as [Al₂O₃], a content of P₂O₅ is defined as [P₂O₅], a total content of alkali metal oxides is defined as [R₂O], and a total content of alkali earth metal oxides is defined as [RO], and
having a compressive stress value (CS₅₀) at a depth of 50 μm from a glass surface of 150 MPa or more.

12. A chemically strengthened glass having a base composition comprising, in terms of mole percentage based on oxides:
SiO₂ in an amount of 45% to 65%;
Al₂O₃ in an amount of 18% to 30%;
Li₂O in an amount of 7% to 15%;
one or more selected from Y₂O₃ and La₂O₃ in a total amount of 2% to 10%;
P₂O₅ in an amount of 2% to 10%; and
ZrO₂ in an amount of 0% to 4%, and
having a compressive stress value (CS₅₀) at a depth of 50 μm from a glass surface of 150 MPa or more.

13. The chemically strengthened glass according to claim 11, having an interparticle distance of particles present in the glass, which is determined by small-angle X-ray scattering (SAXS) measurement, of 2 nm to 100 nm.

14. The chemically strengthened glass according to claim 11, having a depth (DOL) at which a compressive stress value is 0 of 60 μm to 120 μm.

15. The chemically strengthened glass according to claim 11, having a surface compressive stress value (CS₀) of 600 MPa to 900 MPa.

16. The chemically strengthened glass according to claim 11, having an internal tensile stress value (CT) of −70 MPa to −120 MPa.

17. The chemically strengthened glass according to claim 11, wherein the compressive stress value (CS₅₀) is 180 MPa or more, and the depth (DOL) at which the compressive stress value is 0 is 80 μm or more.

18. The chemically strengthened glass according to claim 11, having a sheet shape with a thickness of 2 mm or less.

19. The chemically strengthened glass according to claim 18, having a curved surface portion with a radius of curvature of 100 mm or less.

20. An electronic device comprising the chemically strengthened glass according to claim 18.
